(19) United States
(12) Patent Application Publication
(10) Pub. No.: US 2025/0287972 A1
(43) Pub. Date: Sep. 18, 2025

(54) AERATED CONFECTIONERY

(71) Applicant: SOCIETE DES PRODUITS NESTLE S.A., Vevey (CH)

(72) Inventors: TIMOTHY JAMES WOOSTER, Orbe (CH); MARTIN ERWIN LESER, Bretigny-sur-Morrens (CH); ISABEL CELIGUETA TORRES, York Yorkshire (GB); ARISTODIMOS LAZIDIS, York Yorkshire (GB)

(21) Appl. No.: 18/684,760

(22) PCT Filed: Aug. 26, 2022
(86) PCT No.: PCT/EP2022/073774

§ 371 Date: Feb. 19, 2024

(30) Foreign Application Priority Data
Aug. 27, 2021 (EP) 21193528.3

(51) Int. Cl. A23G 3/52; A23G 3/34; A23G 3/44; A23G 3/46; A23G 3/48

(52) U.S. Cl. CPC A23G 3/52; A23G 3/346; A23G 3/44; A23G 3/46; A23G 3/48

(57) ABSTRACT

The invention relates to a water-based aerated confectionery product and methods of making the same. In particular, the invention relates to stable acidic aqueous mousses comprising aggregated whey protein and sugar. In one aspect, the invention provides a water-based aerated confectionery having a pH less than 5.5 and a water activity less than 0.67, wherein the aerated confectionery comprises 30 wt % to 90 wt % sugar and between 1 wt % to 8 wt % protein. The protein stabilises the water-based aerated confectionery.

### CROSS REFERENCE TO RELATED APPLICATIONS

The present application is a National Stage of International Application No. PCT/EP2022/073774, filed on Aug. 26, 2022, which claims priority to European Patent Application No. 21193528.3, filed on Aug. 27, 2021, the entire contents of which are being incorporated herein by reference.

### FIELD OF THE INVENTION

This invention relates to a water-based aerated confectionery product and methods of making the same. In particular, the invention relates to stable acidic aqueous mousses comprising aggregated protein and sugar.

### BACKGROUND OF THE INVENTION

Aerated confectionery products are made in both artisanal and industrial processes.

In chocolate confectionery the format, production method and distribution channel require products to be microbiologically stable in ambient conditions for typically 9 to 12 months. This is practically achieved by ensuring that the water activity of the product is low enough to prevent the proliferation of pathogenic bacteria, yeasts and moulds. The upper limit of water activity for chocolate products is 0.67. Products with a wafer or biscuit element have lower water activity requirements (typically 0.45) to protect the typical sensory characteristics of elements that are sensitive to moisture.

This low water activity is usually achieved by avoiding the use of water-based systems, which in turn explains the primary use of fat-based fillings in confectionery. Fat based fillings can be successfully aerated, but are perceived as “heavy” and the texture that they provide is far from the mousses, milkshakes and whipped creams that consumers associate with aerated structures. From a nutritional point of view, fat-based fillings also contain saturated fatty acids (SFA) and generally have higher calorific value than sugars, which are the main constituent of water-based systems.

Water-based systems have a lighter and softer perception, are free of SFA and have lower calorific value, but contribute significantly to the sugars of the product. The water activity of these systems is challenging because all of the solids are suspended in water, which although limited, can significantly increase the water activity. This can be addressed either by replacing part of the water with a sugar alcohol that has high humectancy (e.g. sorbitol or glycerol) or by an increase of the solids of the system by adding more sugar. The choice of sugars is important to achieve a system that still flows in a low moisture matrix and room temperature. Also, the sugars in the system should not crystallise over time to an extent that are perceivable by the consumer, since they are in a metastable state at this high total solids content. This technology is known to the art and although the use of sugar alcohols is prevalent, consumers are not entirely comfortable with them on the label, and there is potential for digestive adverse side effects.

The main benefit of water-based confectionery fillings is that they have a softer texture that can be easily modulated with the use of a hydrocolloid. They also deliver very efficiently water-based flavours such as those from fruits, coffee and caramel. Finally, they do not contribute to the fat or SFA content of the product and have a lower price than vegetable fats.

The aeration of water based systems is possible but a surface active species such as a protein or surfactant is required, whereas in fat systems the fat crystals stabilise the gas bubbles. This together with the fact that the viscosity is lower (to gain the advantage of a soft texture) makes it very challenging to provide stable gas bubbles throughout the shelf-life of an aerated water-based product.

WO-A-2014/017525 describes a low-fat or fat-free air bubble-containing emulsion, which contains a whey protein aggregate. Ice creams are described and the overrun (volume increase, or “whippability”) stability was measured at −18° C. The PH levels for the protein aggregate solution are 5.5-7 (neutral pH).

EP1839495 B1 describes whey protein micelles and their use in protein enriched frozen desserts. The pH of this product is between 5.8-6.6.

WO-A-2018148390A1 describes a shelf-stable mousse mixed with a fat-containing product.

EP-A-3197293 describes whippable food products, whipped food products, and methods of making the same. The whippable food product has less than 5% by weight fat and includes about 0.5% to about 30% by weight of a dietary fibre; about 50% to about 95% by weight of water; up to about 5% by weight of a protein; up to about 5% by weight of a food starch; up to about 5% by weight of an emulsifier; and up to about 5% by weight of a hydrocolloid.

U.S. Pat. No. 7,700,144 B2 describes high protein aerated food compositions. The compositions comprise hydrocolloids and added fibre.

WO-A-2007/008560 A9 describes stabilized edible foams and formulations for palatable foams with enhanced stability. In certain embodiments, the formulations include a base liquid (such as milk), a surfactant, a polysaccharide, and a polymer capable of molecular interaction with the polysaccharide.

There remains a need for improved foods with textures and appearances that are appealing to consumers while having nutritional benefits and favourable manufacturing and storage characteristics.

### SUMMARY OF THE INVENTION

The invention relates to aqueous aerated confectionery such as mousses and foams that are stabilized against drainage and sugar crystallisation. In particular, the invention relates to acidic aerated aqueous confectionery comprising aggregated protein and sugar. The aggregated protein is preferably whey protein. The sugar is preferably a blend of different sugars, more preferably comprising fructose.

A first aspect of the invention provides a water-based aerated confectionery comprising sugar and aggregated protein, having a pH less than 5.5 and a water activity less than 0.67. The pH is preferably between pH 2 and pH 5, more preferably around pH 3 to pH 4. The water activity is preferably above 0.45 and below 0.67, for example 0.5 to 0.6. In some embodiments, the water activity is below 0.64 or below 0.59.

The confectionery comprises 30 wt % to 90 wt % sugar and between 1 wt % to 8 wt % protein. The protein stabilises the water-based aerated confectionery.

The confectionery is water-based and not fat-based.

The water-based aerated confectionery comprises water. This may be present as part of a sugar syrup or other ingredient (e.g. flavouring such as fruit juice), and/or as separately added water. Sugar syrup usually contains around 20 wt % to 30 wt % water or around 20 wt % to 25 wt % water, for example around 23 wt % of the exemplified inverted “IS221” syrup is water.

When separately added, the water is preferably added at between 0.1 wt % and 10 wt % of the total ingredients, for example 1 wt % to 10 wt %, 1 wt % to 8 wt %, 2 wt % to 8 wt % or 3 wt % to 7 wt %. The total water content from all sources is preferably greater than 5 wt % and less than 40 wt %, more preferably 30 wt % or less, for example 10 wt % to 30 wt %. In some embodiments, the water content is between 10 wt % and 20 wt %, for example around 14 wt %, 15 wt % or 16 wt %, or such as around 10 wt %, 11 wt %, 12 wt %, 13 wt %, 17 wt %, 18 wt %, 19 wt % or 20 wt %. In one embodiment, the total water content from all sources is between around 20 wt % and 27 wt %, for example around 25 wt %, or around 21 wt %, 22 wt %, 23 wt %, 24 wt %, 26 wt % or 27 wtt %.

In most preferred embodiments, the total water content is from 10 wt % to 30 wt %, preferably between 12 wt % and 27 wt % and more preferably between 15 wt % and 25 wt %.

The wt % water content may be determined by measuring the amount of water in the sample by Karl Fischer titration that is based in the reaction of water with iodine in the presence of sulphur dioxide. The determination involves a known weight of sample to be mixed in a methanol, n-hexane solvent and then titrated with Karl Fischer reagent (which consists of iodine, sulfur dioxide, a base and a solvent, such as alcohol) up to the equivalence point which is detected by voltammetry and the amount of water is defined allowing the calculation of the humidity of the sample.

The aerated confectionery has a water activity below 0.67, preferably above 0.45 and below 0.67. In some embodiments, the water-based aerated confectionery has a water activity of no greater than 0.64, no greater than 0.62, or no greater than 0.59. The water activity is preferably greater than 0.45. The water activity may be between 0.5 and 0.59, for example around 0.54, in some embodiments. Suitable water activities according to the invention include 0.66, 0.65, 0.64, 0.63, 0.62, 0.61, 0.60, 0.59, 0.58, 0.57, 0.56, 0.55, 0.54, 0.53, 0.52, 0.51, 0.50, 0.49, 0.48, 0.47 and 0.46. Preferred water activities include 0.64, 0.63, 0.62, 0.61, 0.60, 0.59, 0.58, 0.57, 0.56, 0.55, 0.54, 0.53, 0.52, 0.51 and 0.50.

The term water activity (“Aw”) is well known in the art, and refers to is the partial vapor pressure of water in a solution divided by the standard state partial vapor pressure of water. In the field of food science, the standard state is most often defined as the partial vapor pressure of pure water at the same temperature. Using this particular definition, pure distilled water has a water activity of exactly one. A water activity of 0.80 means the vapor pressure is 80 percent of that of pure water. Water activity values are preferably obtained by either a resistive electrolytic, a capacitance or a dew point hygrometer, as known in the art. Water activity values according to the invention are most preferably determined by enclosing a sample in a sealed container. The relative humidity of the air in the headspace will equilibrate with the water activity of the sample. At equilibrium, the two will be equal, and the relative humidity of the headspace can be measured using an electrical capacitance sensor to determine the water activity of the sample.

The aerated confectionery is preferably a mousse or a foam.

The aerated confectionery has a pH less than 5.5, preferably between 2 and 5.4. In some embodiments, the aerated confectionery has a pH of about 4.2 or less, for example a pH of between 2 and 4.2, a pH of between 2 and 4, a pH of between 2.5 and 4, or a pH between 2.5 and 3.5, for example around pH 3.

In preferred embodiments, the pH is between 2 and 4.2, preferably between 2.25 and 4, preferably between 2.5 and 3.75, and most preferably between 3.0 and 3.75. As shown in the Examples below, these pH ranges provide the optimum balance between whipping properties and textures (which impacts depositing properties), as well as contributing to the overall taste in a positive manner.

The pH is preferably measured at ambient conditions, preferably at a temperature of 20° C., using equipment known in the art.

The pH of the water-based aerated confectionery compositions of the present invention may be provided by the ingredients per se without the need for additional pH modification. However, if pH lowering is required, a food-grade acid is preferably added to aid pH control. For example, food-grade acids that may be used are preferably selected from the group consisting of acetic acid, citric acid, tartaric acid, malic acid, folic acid, fumaric acid, and lactic acid and mixtures thereof. The acid may be added in any suitable form, e.g. powder. In a preferred embodiment, the water-based aerated confectionery comprises the acid in an amount of between 0.1 wt % and 5.0 wt %, preferably 0.2 wt % and 3.5 wt %, and more preferably between 0.3 wt % and 3.0 wt %, preferably these ranges relate to the weight of the acid and not the weight of any solvent (e.g. water). Preferably these percentages relate to the dry weight of the acid added, preferably in the form of a powder.

In some embodiments, the pH is between 2 to 4, for example around 3, and the water content is between 10 wt % and 20 wt %, for example around 14 wt %.

The protein may preferably be aggregated. The protein is preferably induced to aggregate by heat, for example heating to a temperature 50° C. or greater, 60° C. or greater, 70° C. or greater or 80° C. or greater, for example between 50° C. and around 100° C., between 60° C. and around 100° C., between 60° C. and around 100° C., for example between 50° C. and around 95° C. In some embodiments, the protein is segregated by heating to between 80° C. and 95° C. Alternatively, the aggregation may be induced by exposure to acid pH, for example pH 2 to 5, such as pH 2, 3, 3.5 or 4. The protein can be aggregated prior to its inclusion in the confectionery, although the production process may be simplified when the protein is added to the confectionery mixture in a native (unaggregated) form and aggregated, for example by heating or contact with the acidic confectionery, as part of the confectionery production process.

The protein is preferably whey protein. This may conveniently be added in the form of whey protein isolate or whey protein concentrate, which terms are known in the art. Whey protein isolate contains a high proportion of whey protein, preferably around 90 wt %, so can conveniently be used. Whey protein concentrate typically contains around 80 wt % whey protein and can also be used.

The 1 wt % to 8 wt % of protein in the confectionery of the invention is the wt % of actual protein, not the wt % of the protein concentrate or isolate (which contain up to 20% of other non-protein components) that can be used to provide the protein. For example, when 1 wt % protein is required in the confectionery, 1.12 wt % of a whey protein isolate comprising 90 wt % protein can be used to provide the required 1 wt % protein. In another example, when 5 wt % protein is required in the confectionery, 6.25 wt % of a whey protein concentrate comprising 80 wt % protein can be used to provide the required 5 wt % protein. When 3.3 wt % of whey protein isolate (comprising 90 wt % protein) is used as an ingredient, this will provide 2.97 wt % protein to the confectionery.

The protein, preferably whey protein, is present at between 1 wt % to 8 wt % of the confectionery. In some embodiments, the protein is present in an amount between 2 wt % to 8 wt % of the confectionery, or in an amount between 2 wt % to 5 wt % of the confectionery optionally at least 2 wt % or at least 3 wt %. Examples of suitable amounts include around 1.5 wt %, 2 wt %, 2.5 wt %, 3 wt %, 3,5 wt %, 4 wt %, 4.5 wt %, 5 wt %, 5.5 wt % and 6 wt %, and all ranges between those exemplary amounts. In some embodiments, the protein is present at 2.5 wt % to 8 wt %, 2.5 wt % to 6 wt %, or 2.75 wt % to 6 wt %.

The aerated confectionery comprises 30 wt % to 90 wt % sugar, for example sugar between 40 wt % and 90 wt %. In some embodiments, the sugar is present at between 40 wt % and 80 wt %, between 40 wt % and 70 wt %, between 50 wt % and 90 wt %, between 50 wt % and 90 wt %, or between 60 wt % and 90 wt %. In some embodiments, the sugar is present at between 70 wt % and 90 wt %, for example between 75 wt % and 90 wt %, such as between 80 wt % and 90 wt %.

In some embodiments, the sugar is a sugar syrup. Suitable sugar syrups include glucose syrup preferably at 40 to 70 Dextrose Equivalent (“DE”), fructose glucose syrup (may also be termed glucose fructose syrup, isoglucose or fructose corn syrup), high fructose syrup, corn syrup, oat syrup, rice syrup or tapioca syrup, or a mixture of any two or more of these syrups.

Undesirable crystallisation of the sugar in the aerated confectionery is shown in the Examples to be reduced or avoided when the sugar comprises or consists of two or more different sugars. In one embodiment, the blend of different sugars is provided by an invert sugar with a sugar conversion percentage (i.e. degree of hydrolysis) at least 10% but below 70%, below 60%, below 50% or below 40%. In some embodiments, the sugar is an invert sugar with a sugar conversion percentage (i.e. degree of hydrolysis) of 20% to 60%, 30% to 50% or 40% to 50%. Invert sugars with incomplete conversion (hydrolysis) are known as partial invert sugars.

This mixture of sugars in the confectionery may comprise a mixture of at least one reducing sugar and at least one non-reducing sugar. Sucrose is a non-reducing sugar while dextrose and fructose are reducing sugars. A partial invert syrup comprises sucrose (non-reducing), dextrose (reducing) and fructose (reducing). The sugar in the aerated confectionery preferably comprises at least 10% but less than 70% reducing sugars, with the remainder being non-reducing sugars. In some embodiments, the sugar comprises 10% to 60% reducing sugars, 20% to 60% reducing sugars, or 30% to 50% reducing sugars. The Examples demonstrate the use of a sugar mixture comprising 40 wt % to 50 wt % (specifically 41 wt % to 49 wt %) reducing sugars. The mixture of reducing sugar and non-reducing sugar can be provided as a partially-inverted sugar syrup.

A fully hydrolysed (˜97% inverted) invert syrup, in which essentially all sucrose is broken down to dextrose and fructose, may crystallise in aerated products. A partially hydrolysed syrup, for example hydrolysis above 10% but below 70%, preferably less than 60% hydrolysed (inverted) is more stable according to the present invention and is resistant to crystallisation.

Invert sugar may be fully inverted sugar syrup or, preferably, partially inverted sugar syrup. Fully inverted sugar syrup comprises only glucose and fructose. Partially-inverted sugar syrup comprises glucose, fructose and sucrose, and is preferred.

In one embodiment, the sugar in the confectionery comprises or consists of partially hydrolysed invert syrup. In another embodiment, the sugar comprises or consists of a mix of sucrose, partially or fully-inverted syrup, and glucose. In a further embodiment, the sugar comprises or consists of a mixture of sucrose, fructose and glucose.

The presence of fructose in the sugar mix is highly preferred. Preferably, between 10 wt % and 50 wt % of the sugar (i.e. from 1/10 to ½ of the sugars, preferably at least ⅕) is fructose. More preferably, around 20 wt % to 30 wt %, for example 20 wt % to 25 wt % of the sugars are fructose. This can be achieved either by blending different sugar rich ingredients (such as powder sugars, starch derived syrups or inverted sugar syrups) or by using a partially inverted sugar syrup comprising sucrose, dextrose and fructose.

Accordingly, a mixture of sugars is preferably used according to the invention.

In a preferred embodiment, the aerated confectionery comprises a sugar mix and the confectionery comprises 5 wt % to 30 wt % sucrose, 5 wt % to 30 wt % glucose syrup and 35 wt % to 75 wt % fructose glucose syrup.

In a more preferred embodiment, the aerated confectionery comprises a sugar mix and the confectionery comprises 10 wt % to 25 wt % sucrose, 10 wt % to 25 wt % glucose syrup and 45 wt % to 65 wt % fructose glucose syrup.

In a preferred embodiment, the aerated confectionery comprises 40 wt % to 85 wt % total monosaccharides and disaccharides, preferably 50 wt % to 80 wt %, and more preferably 60 wt % to 80 wt %.

In a highly preferred embodiment, the above compositions comprising a sugar mix have a pH of about 4.2 or less, for example a pH of between 2 and 4.2, and preferably a pH of between 2 and 4, and more preferably a pH of between 2.5 and 4.

When sugar syrup is used, this can conveniently provide the aqueous component of the confectionery so that additional water is not required. For example, in some embodiments a confectionery of the invention can consist essentially of sugar syrup, aggregated protein and one or more flavourings. In some embodiments, the confectionery comprises, consists of or consists essentially of 50 wt % to 90 wt % (e.g. 65 wt % to 90 wt %) invert (partial or full) sugar syrup, 1 wt % to 8 wt % (e.g. 2 wt % to 6 wt %) aggregated protein, and the balance provided by flavours or other agents.

As shown in the Examples, stable aerated confectioneries have been provided consisting of sugar syrup, aggregated whey protein and flavouring. The syrup may be present in some embodiments at 50 wt % to 90 wt %, 65 wt % to 90 wt %, 75 wt % to 90 wt %, or 90 wt % to 90 wt %. The protein may be present at any amount describe herein, for example 1 wt % to 8 wt %, 2 wt % to 6 wt % or 3 wt % to 5 wt %, for example around 2.5 wt % or more, around 3 wt % or more, around 4 wt % or more, or around 5 wt %. The flavouring may be present at between 1 wt % to 30 wt % of the confectionery, for example between 5 wt % to 25 wt % or around 10 wt % to 20 wt %.

A non-limiting example of a confectionery described in the Examples below, comprises 80 wt % to 90 wt % (e.g. 86 wt % to 87 wt %) sugar syrup, 3 wt % to 4 wt % whey protein and 10 wt % flavouring (e.g. coffee granules). The Examples also demonstrate the successful provision of another non-limiting exemplary confectionery comprising 2 wt % to 2.5 wt % (e.g. 2.3 wt %) whey protein and 65 wt % to 70 wt % (e.g. 68 wt % to 69 wt %) partially invert sugar syrup, plus flavourings.

In some embodiments, the total amount of sugar in the aerated confectionery is between 60 wt % to 80 wt %, or 60 wt % to 70 wt %.

The aerated confectionery of the invention is stabilised by the aggregated protein. Therefore, while additional agents can optionally be included such as gelling agents or setting agents, they are not required. The aerated confectionery provides a favourable texture and mouthfeel, so fat is not required and can be excluded, thereby providing a healthier fat-free product. Accordingly, in some embodiments the water-based aerated confectionery is substantially or completely devoid of fat, hydrocolloids, gelling or setting agents and/or thickeners.

In the present invention, the terms “substantially or completely devoid of” preferably mean the aerated confectionery comprises 3 wt % or less, 2 wt % or less, 1 wt % or less, less than 0.1 wt %, or most preferably 0 wt % of said ingredients.

In some highly preferred embodiments, the aerated confectionery comprises 3 wt % or less, 2 wt % or less, 1 wt % or less, less than 0.1 wt %, or most preferably 0 wt % of fat.

In some embodiments, the aerated confectionery comprises 3 wt % or less, 2 wt % or less, 1 wt % or less, less than 0.1 wt %, or 0 wt % of a setting agent such as gelatin or pectin.

The aerated confectionery of the invention does not require egg based whipping agents, such as egg white or purified proteins from the egg white such as the albumen. Accordingly, in some embodiments egg proteins are absent from the aerated confectionery of the invention. In some embodiments the aerated confectionery is substantially or completely devoid of egg protein. In some highly preferred embodiments the water-based aerated confectionery is substantially or completely devoid of any ingredients derived from eggs. In some highly preferred embodiments, the aerated confectionery comprises 3 wt % or less, 2 wt % or less, 1 wt % or less, less than 0.1 wt %, or most preferably 0 wt % of ingredients derived from eggs.

The aerated confectionery of the invention does not require the addition of a surfactant. The protein preferably provides the necessary interfacial stabilisation and/or plateau border stabilisation. Therefore in some embodiments there is no added surfactant. In one embodiment, there is no artificial, synthesized or chemical surfactant. In one embodiment, there is less than 0.1 wt % surfactant, or no detectable surfactant, in the aerated confectionery of the invention.

In a preferred embodiment, the aerated confectionery of the invention does not require a stabilizer other than the, preferably aggregated, protein.

There is preferably no fat in the aerated confectionery, so a fat emulsifier is not required. In one embodiment, the aerated confectionery of the invention does not comprise an emulsifier.

The aerated confectionery of the invention does not require fibre. In one embodiment, the aerated confectionery of the invention is very low fibre or free of fibre.

In some embodiments, the water-based aerated confectionery has a bulk viscosity of at least 10 Pa·S, for example 10 Pa·S to 50 Pa·S or preferably 10-25 Pa·s. More preferably, the confectionery has a viscosity around 10-20 Pa·S, most preferably 10-18 Pa·S or 10-16 Pa·S.

The viscosity recited above may be assessed as follows, preferably at 25° C. Rheological properties of the non-aerated masses were measured by performing oscillatory rheolometry. These measurements were performed using a Physica MRC 500 rheometer (Anton Paar) equipped with a sanded Couette geometry (CC27-SN23479) and a Peltier system for temperature control. The Couette geometry was composed of a cup (14.46 mm radius) and a bob system (13.33 mm radius,40 mm length). Samples were covered with a low-viscosity silicone oil (Sigma Aldrich Ltd, Singapore) to avoid evaporation during measurements. The sample rested for 5 minutes at 25° C. before starting the experiments. The imposed frequency (1 Hz) and strain (0.5%) during oscillatory shear measurements were chosen within the linear response regime.

The aerated confectionery can be very significantly aerated with an overrun of at least 50%, for example around 100% or more. The overrun can be at least 125% or at least 150% in some embodiments. The overrun may be as high as up to 500% in some embodiments. The overrun is preferably 60% to 200%, more preferably 60% to 160%.

In some embodiments, the confectionery is aerated to a bulk density of 0.9 gr/cm³ or less, 0.8 gr/cm³ or less, for example 0.6 gr/cm³ or less, such as around 0.4 g/cm³. By controlling the upper limit of the density, the whippability of the water-based aerated confectionery compositions is preferably optimised. A lower number for bulk density means more aeration. In some embodiments, the confectionery is aerated to a bulk density of 0.1 gr/cm³ or more, for example 0.2 gr/cm³ or more, such as 0.3 g/cm³ or more. By controlling the lower limit of the density, the flow properties necessary for depositing such compositions in confectionery products is optimally controlled. Hence, in embodiments, the bulk density is between 0.1 gr/cm³ and 0.9 gr/cm³, for example between 0.2 gr/cm³ and 0.8 gr/cm³. The term bulk density is used as the density includes the total volume, i.e. includes the pores (or voids or gas etc.) present in the water-based aerated confectionery.

In a preferred embodiment, the bulk density is preferably between 0.4 gr/cm³ and 0.8 gr/cm³, more preferably between 0.45 gr/cm³ and 0.75 gr/cm³ and most preferably between 0.50 gr/cm³ and 0.70 gr/cm³. As shown in the examples, these density ranges provides a balance between the whippability and flow properties necessary for depositing such compositions in confectionery products, preferably confectionery shells.

The water-based aerated confectionery of the invention preferably comprises one or more flavourings. Preferably, these flavourings contribute more than flavouring to the composition, e.g. may contribute bulk, nutritional properties etc., i.e. preferably these flavourings are not high intensity flavouring compositions. A flavouring may be included at between 1 wt % to 30 wt % of the confectionery, for example around 10 wt % to 20 wt % or 1 wt % to 10 wt %. The flavouring is preferably consistent with the acid (pH 5.5 or less) nature of the confectionery, i.e. the flavouring is preferably acidic and/or recognised as “tart” or “tangy”. Such flavourings may comprise or consist of fruit, fruit juice, dried fruit or fruit concentrate, optionally between 10 wt % and 30 wt % or between 1 wt % and 10 wt %. Other suitable flavourings include coffee, preferably dehydrated coffee powders/granules (e.g. instant coffee) or caramel.

When coffee is used as a flavouring, the pH of the confectionery is naturally reduced. In the case of a caramel flavour a suitable acid can be added to maintain the required pH. When juice is used as the flavouring, this may or may not require supplementation with citric acid to achieve the desired pH, depending on the type and amount of juice.

When the flavouring includes sugars, for example fruit juice, dried fruit or fruit concentrate, the amount of sugar that is added as a separate ingredient is reduced accordingly.

The water-based aerated confectionery is stable. This means that it has an acceptable shelf-life between manufacture and consumption by the consumer, so that it has an acceptable appearance, taste and texture at the point of consumption. For a mousse, this means that the mousse is recognisable as a single mass and has not begun visible separation into a liquid phase (i.e. notable drainage has not occurred), nor has visible crystallisation of the sugars occurred.

Preferably, the aerated confectionery is stable for at least one month. Stability is usually determined by what a consumer determines as acceptable, but can also be formally assessed on the basis of drainage stability, sugar crystallisation and/or coarsening of the mousse bubbles as described in the Examples herein.

In simple terms, mousse or foam drainage refers to the pooling of liquid at the bottom of the foam or mousse. A stable mousse or foam is one without visible pooling after the set time period. Therefore, a mousse stable for three months does not show pooling visible by eye after three months. A foam stable for six months does not show visible pooling after six months.

A stable mousse or foam does not show visible sugar crystallisation. A foam stable for six months does not show sugar crystallisation visible to the eye after six months.

In some embodiments, the water-based aerated confectionery is stable for at least three months, preferably at least six months.

Stability can be assessed at ambient temperature preferably 20° C. or 18° C., or at a refrigerated temperature, preferably 4° C.

In a preferred embodiment, the water based aerated confectionery of the invention is not frozen nor is baked, i.e. the present invention relates to compositions at ambient or refrigerated temperatures, preferably not below 0° C. and not above 100° C. Freezing or baking provides inherently different compositions from the desired aerated, “foamy” mouthfeel of the water-based compositions of this invention. Freezing provides solidified mixtures and baking water-based protein mixtures may lead to textures more akin to meringues.

In an alternative embodiment, the confectionery of the present invention may be frozen to provide a frozen confectionery. This may be achieved using well known, not particularly limited techniques, for example, using a freezer at −20° C. to −18° C. for a required time between 2 and 6 hours. However, the more preferred embodiments are ambient or refrigerated products.

In one embodiment, a water based aerated confectionery of the invention comprises 5 wt % to 25 wt % flavouring such as fruit concentrate, 2 wt % to 4 wt % aggregated whey protein isolate, and 60 wt % to 80 wt % invert sugar syrup with preferably greater than 50% conversion but less than 70% conversion, preferably between 55% and 65%.

In some embodiments, the confectionery comprises 2 wt % to 4 wt % whey protein isolate and 60 wt % to 80 wt % partial invert sugar syrup, 0.01 wt % to 0.25 wt % of a thickening agent (e.g. K-carrageenan) and 1 wt % to 4 wt % fruit powder. For example, one non-limiting exemplified confectionery comprises 2.3 wt % whey protein isolate and 69.8 wt % invert sugar syrup, 0.05 wt % K-carrageenan and 2 wt % fruit powder. Fruit juice, for example lemon juice, may be included preferably at around 2 wt %. The balance is preferably water.

Another described confectionery comprises 80 wt % to 90 wt % partially inverted sugar syrup, 2 wt % to 4 wt % aggregated whey protein isolate and 5 wt % to 15 wt % flavouring such as coffee granules. For example, one non-limiting exemplified confectionery comprises 86.7 wt % invert sugar syrup, 3.3 wt % aggregated whey protein isolate and 10 wt % coffee granules.

A further aspect of the invention provides a confectionery product comprising the water-based aerated confectionery of the invention. Preferably, the water-based aerated confectionery forms the filling of a chocolate, candy or sweet. Accordingly, one embodiment provides the water-based aerated confectionery at least partly surrounded or encased in chocolate, preferably a chocolate shell. In a preferred embodiment, the surrounding or encasing encompasses between 40% and 100% (a closed shell), preferably between 50% and 100%, and more preferably between 75% and 100% of the surface area of the filling is encompassed by the shell.

A further aspect of the invention provides method of making a water-based aerated confectionery, comprising introducing air into a liquid mass, wherein the liquid mass has a pH between 2 and 5.5 and a water activity less than 0.67 and preferably greater than 0.45. The liquid mass comprises at least 30 wt % sugar and between 1 wt % to 8 wt % protein.

The step of introducing air into the liquid mass can comprise mechanical introduction of the air (e.g. whipping) or gas injection (e.g. nitrogen gas). The method of the third aspect of the invention can comprise the step of making the liquid mass into which the air is introduced. This step can comprise mixing at least whey protein and sugar, optionally in water, at a temperature of 50° C. or greater, preferably between 80° C. and 95° C.

A further aspect of the invention provides a confectionery suitable for aeration, wherein the confectionery has a pH less than 5.5 and a water activity less than 0.67, and comprises at least 30 wt % sugar and between 1 wt % to 8 wt % protein.

A further aspect of the invention provides a method of making confectionery suitable for aeration, comprising the steps of:
(i) forming an aqueous mixture comprising sugar and whey protein, wherein the whey protein is present in the mixture at between 1 wt % and 8 wt %; and
(ii) heating the mixture to at least 50° C., preferably at least 80° C., more preferably between 80° C. and 95° C. to aggregate the whey protein.

This may further comprise the step of (iii) introducing air into the mixture comprising aggregated whey protein.

A further aspect of the invention provides a method of stabilising an aerated confectionery, comprising the step of adding aggregated protein, preferably aggregated whey protein, to the confectionery prior to aeration. A further aspect of the invention provides the use of aggregated whey protein as a stabiliser for aerated confectionery such as a mousse.

### BRIEF DESCRIPTION OF THE DRAWINGS

FIG. 1 shows A) the effect of bulk sugar (bulk viscosity) on foam overrun and stability, B) foam microstructure, and C) foam destabilisation mechanisms.

FIG. 2 shows an initial assessment of the performance of different protein based emulsifiers on mousse performance A) overrun, and B) mousse stability. All recipes had a pH of 4, contained 87 wt % invert syrup DE 63 and had a final water activity <0.68. Foams were prepared by whipping 300 grams of liquid filling in a Hobart mixer for 3 minutes.

FIG. 3 shows assessment of A) long term drainage stability and B) low shear rheology as a function of temperature of A) aerated or B) non-aerated raspberry aqueous mousse fillings stabilized by differing amounts of whey protein isolate i) 1.1 wt %, ii) 2.2 wt %, iii) 3.3 wt %, iv) 4.4 wt % and v) 6.6 wt %.

FIG. 4 shows raspberry mouse filling containing 20% raspberry fruit concentrate and 74% invert syrup stabilized by 3.2% whey protein isolate (BiPro) and 1% pectin (LM or HM). A) photographs of bulk mouse filling after 10 weeks of storage at 18° C. and B) polarized light micrographs of red spots showing the presence of crystalline material, most likely sugar.

FIG. 5 shows results of the stability test over 26 weeks at 4°, 18° and 25° C. storage temperature. Samples A-E were made with the sugar mix (sucrose, inverted syrup and glucose 63DE), and E-G using the IS221 partial invert sugar syrup. “No 26w” indicates that under these conditions no significant drainage or sugar crystallization, respectively, was observed after 26 weeks of storage.

FIG. 6 shows summarizes the detailed stability behaviour of the Samples A-E from FIG. 5, against drainage as a function of time.

FIG. 7 shows systematic change in low shear bulk viscosity of raspberry mousse filling base as a function of sugar type, water activity and temperature.

FIG. 8 shows the master curve relationship between mousse drainage after 17 weeks storage at 4° C., 18° C. and 25° C. and low shear viscosity measured at the same temperature and water activity of numerous different raspberry mousse preparations with different sugar types and water activities.

### DETAILED DESCRIPTION OF THE INVENTION

The present inventors have developed a surprising technology based on an increased understanding of the feasibility of water-based aerated confectionery such as fillings for chocolates. Such fillings are desired by consumers, in particular within chocolate products.

Detailed investigations by the inventors revealed that undesirable mousse drainage is inversely proportional to the bulk viscosity of liquid filling. Water-based aerated confectioneries have surprisingly been created that are stable in ambient conditions for at least 6 months with no visible drainage or sugar crystallisation.

The present inventors conducted systematic studies to address the key hypotheses: how to stabilize acidic mousses using aggregated proteins; how to prevent mousse drainage by regulating plateau border viscosity; and how to prevent sugar crystallisation in the humectant mix by limiting the concentration of a single sugar below its saturation.

The results of these extensive investigations showed that heat induced aggregation of whey protein surprisingly improved foam performance, with increasing aggregated protein contents showing superior stability. Long term stability studies at various ambient (18, 20 and 25° C.) and chilled (4° C.) conditions demonstrated that aqueous mousses according to the invention are stable against drainage and sugar crystallization for at least 6 months. The Examples demonstrate that the stability of ambient stable aqueous mousse fillings is inversely proportional to the bulk viscosity of liquid filling. Exemplified aerated products are stable for 6months with no visible drainage and can be incorporated, for example, into filled chocolate confectionery products.

The key scientific challenge was how physically to stabilize aqueous mousses against drainage and coarsening, and how to prevent crystallization of sugars during mousse lifetime.

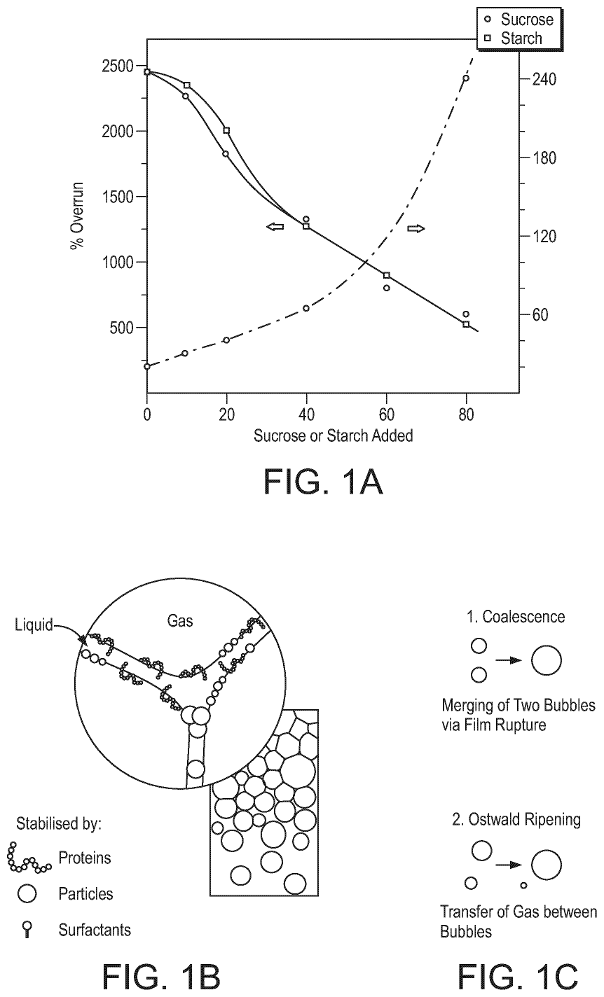

Mousses undergo two main types of destabilization (FIG. 1C); i) drainage of the liquid from the bubbles and ii) coarsening of the bubble size distribution via coalescence and Ostwald ripening. Ostwald ripening is the transfer of air from small bubbles to the larger bubbles due to the difference in Laplace pressure.

Without wishing to be bound by theory, drainage of the mousse plateau border can be slowed by reducing liquid flow between adjacent bubbles by increasing bulk liquid viscosity (via, i) sugar type, ii) moisture content (or water activity), iii) temperature or iv) hydrocolloids and/or v) by restricting flow by clogging/plugging the plateau border with protein aggregates.

Coarsening of the mousse bubbles can be slowed by: i) having a viscoelastic interface that prevents coalescence and potentially slows Ostwald ripening by providing a resistance to bubble shrinkage.

Crystallization of the humectant sugar mix that is the aqueous phase can be prevented by controlling the total concentration of a single small sugar either by controlling the extent of sugar inversion or by using a blend of different sugars.

The data presented in the Examples demonstrate the validity of these approaches to physically stabilizing ambient aqueous mousses.

The invention provides a water-based aerated confectionery having a pH less than 5.5 and a water activity less than 0.67. The confectionery comprises sugar and protein. The protein is preferably aggregated during processing by application of heat in the given pH. The protein stabilise the water-based aerated confectionery. The confectionery preferably comprises 30 wt % to 90 wt % sugar and between 1 wt % to 8 wt % aggregated protein.

One aspect of the invention provides an aerated confectionery product, preferably a foam or a mousse, created with whey protein isolate (WPI) or a whey protein concentrate (WPC), wherein the aerated confectionery product is: acidic with a pH lower than about 5.5, highly viscous because of 30 wt % to 90 wt % sugar, and has a Aw of lower than 0.67, preferably between 0.5 and 0.64 or between 0.5 and 0.59. The product is stabilized by whey protein that is denatured and preferably does not contain (or only optional) hydrocolloids/thickeners.

Without wishing to be bound by theory, the viscosity is thought to control drainage in these foams. The aerated product is stable for several months without drainage at a temperature from 4° C. up to room temperature.

Some embodiments provide a stable foam that it is fat free, does not contain hydrocolloids or thickeners, and has a pH between 2 and 4.

Certain exemplary embodiments are presented in the table below.

| | Raspberry | Raspberry | Passion fruit | Mint | Coffee |
|---|---|---|---|---|---|
| Ingredient | Filling~% | Filling #2~% | Filling~% | Filling~% | Filling~% |
| Whey Protein Isolate | 2.2 | 2.2 | 2.4 | 2.2 | 2.4 |
| Raspberry Puree 63 | 20 | 10 | \ | \ | \ |
| BX | | | | | |
| Raspberry Flavour | 0.2 | 0.2 | \ | \ | \ |
| Givaudan | | | | | |
| Passion Fruit Puree | \ | \ | 15 | \ | \ |
| Conc. Lime Juice | \ | \ | \ | 15 | \ |
| Mint flavour | \ | \ | \ | 0.3 | \ |
| Dried Coffee | \ | \ | \ | \ | 10 |
| Inverted Syrup | 76 | 81 | 82 | 82 | 87 |
| Water | 1.6 | 6.6 | 0.6 | 0.6 | 0.6 |
| Total | 100 | 100 | 100 | 100.1 | 100 |

These exemplary embodiments reflect that the invention relates to acidic aerated aqueous confectionery comprising aggregated protein and sugar.

Commonly, in the field of confectionery flavourants and colourants are added to intensify the taste and visual appeal of the products. These additives are generally intense in their properties and are added in small amounts as a highly active agent in a water-based or oil-based matrix, dependent on the solubility of the active agent. In embodiments where additives (preferably colourants and/or flavourants, preferably compounds that are added only to provide colour and/or flavouring, i.e. do not provide significant nutritional, bulking etc. properties contrary to, for example, the fruit juice concentrates mentioned above) are included in the water-based aerated confectionery, the additives are water-soluble (i.e. are not oil-soluble). It is understood that the term “soluble” has the understood meaning in the art, i.e. ability to be dissolved in a specific medium at ambient conditions, preferably at 20° C.

### Aggregated Protein

The Examples demonstrate the stabilisation of acidic mousses with aggregated protein. In particular, foam drainage stability is shown to be boosted by higher levels of aggregated whey protein from whey protein isolate. Heat aggregation is also shown to boost low shear bulk viscosity, thereby stabilising mousses.

The invention generally relates to the use of a protein to create a stabilised foam in acidic conditions in a high sugar, optionally fat-free system. The protein is aggregated protein, in particular aggregated whey protein.

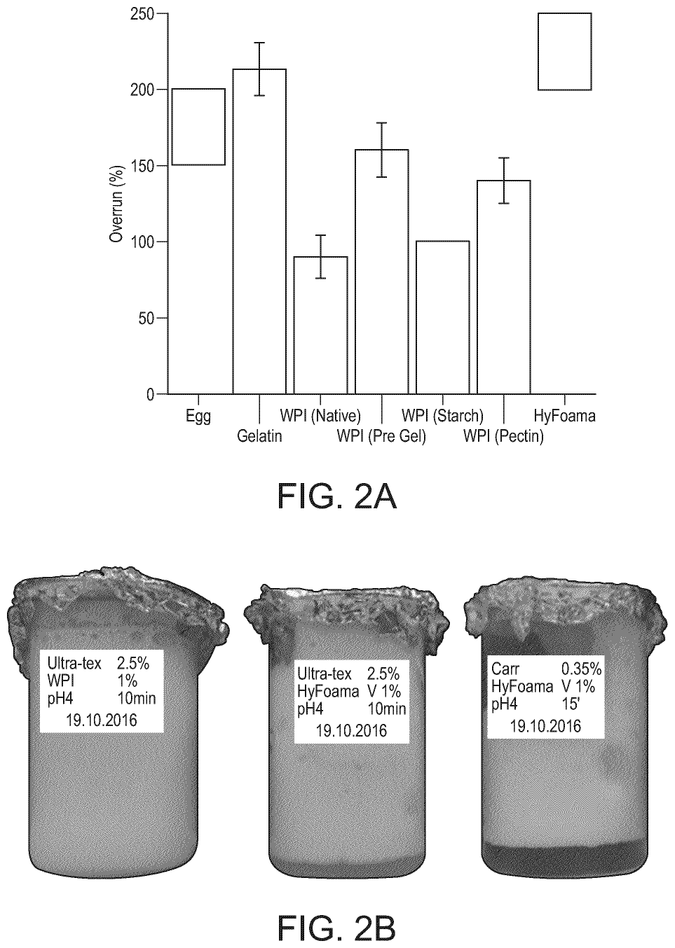

The inventors observed that native milk proteins do not foam as well as aggregated proteins (FIG. 2). Hydrolysis of milk proteins boosts overrun, but have high drainage and coalescence as compared to aggregated proteins. Aggregation of whey protein also boosts overrun and advantageously provides good foam stability. Therefore, aggregated proteins are preferably selected to stabilise aerated confectionery.

The aggregated protein is preferably whey protein. This may be provided by whey protein isolate or whey protein concentrate, which terms are known in the art.

An example of whey protein isolate (WPI) is BiPro® 9500, commercially available from Agropur Inc., Eden Prairie, MN 55344 USA. Whey protein isolate such as BiPro® 9500 preferably is manufactured from fresh, sweet dairy whey that is concentrated and spray dried. Whey protein isolate is preferably lactose-free based on US regulatory labelling of sugars and carbohydrates in products that contain less than 0.5 g per serving as “0 g” or “Sugar Free”. Whey protein isolate preferably comprises a maximum of 3 wt % ash, 1 wt % fat, 0.5 wt % lactose and 5 wt % moisture. Whey protein isolate preferably comprises primarily beta-lactoglobulin and alpha-lactalbumin, at around 85 wt % to 95 wt % (e.g. 90 wt %) protein.

Another commercially-available whey protein isolate that can be used according to the invention is the “WPI” product available from Sachsenmilch Leppersdorf GmbH, Leppersdorf, Germany. This preferably contains around 0.1 wt % fat, around 90 wt % protein (around 92 wt % of the dry matter), around 1.8 wt % lactose, up to 3 wt % ash and 4 wt % water.

Whey protein isolate is preferably not denatured and is soluble over a pH range of pH 2 to pH 9. Therefore, aggregation of WPI is preferably required for use in the present invention.

An example of whey protein concentrate (WPC) is the WPC80 product that is commercially available from Fonterra, Heerenveen, Netherlands. WPC is preferably around 75 wt % to 85 wt % protein (e.g. around 80 wt %) and comprises small amounts of fat (e.g. 5 wt %), moisture (e.g. 5 wt %), ash (e.g. 3 wt %) and lactose (e.g. 5 wt %).

The aggregated protein is preferably induced to aggregate by heat, for example heating to a temperature 50° C. or greater, 60° C. or greater, 70° C. or greater or 80° C. or greater, for example 80° C. to 95° C. Alternatively, the aggregation may be induced by exposure to acidic pH, preferably between pH 2 and pH 5.

In a preferred embodiment, the aggregation may take place over a time period of greater than 2 minutes, greater than 5 minutes or greater than 10 minutes. For example, the time period may be less than 1 hour, less than 45 minutes or less than 30 minutes. For example, between 2 minutes and 1 hour.

In some embodiments, the protein is present in an amount at least 2 wt % of the mousse, optionally at least 2 wt % or at least 2.2 wt %, or at least 3 wt % or 3.3 wt %. Favourable effects may be obtained with higher levels of aggregated protein.

### Sugars

The Examples also show the stabilisation against draining using sugars. In particular, the interaction of temperature, water content and sugar type control mousse drainage.

Mousse destabilisation caused by liquid draining can be controlled by controlling the bulk viscosity. Undesirable sugar crystallisation can also be controlled through sugar blending. Combined, these features provide aerated confectionery that are stable for weeks or months, for example 6 months or more.

The aerated confectionery is preferably high in sugar, for example comprising sugar at between 40 wt % and 90 wt %. In some embodiments, the total amount of sugar in the aerated confectionery is between 60 wt % to 80 wt %.

In some embodiments, the sugar is a sugar syrup. Suitable sugar syrups include glucose syrup preferably at 40 to 70 Dextrose Equivalent (“DE”), fructose glucose syrup, high fructose syrup, corn syrup, oat syrup, rice syrup or tapioca syrup. A mixture of two or more of these syrups can be used.

Such syrups are well known in the art. Glucose syrups are well known in the art and are obtained by hydrolysis of starches, generally vegetable starches. Glucose syrups are described in Glucose Syrups, Technology and Applications, Peter Hull, Wiley-Blackwell 2010.

In a preferred embodiment, the glucose syrup has a DE value in the range of 35-95, preferably in the range of 35-70 or 40-70, more preferably in the range of 35-63.

Similarly, fructose glucose syrups are prepared from hydrolysis of starch, generally vegetable starches, and then isomerisation to produce fructose. As in the production of conventional corn syrup, the starch may be broken down into glucose by enzymes. To make the fructose corn syrup, the corn syrup is further processed by D-xylose isomerase to convert some of its glucose into fructose. Common commercially used syrups are “HFCS 42” and “HFCS 55” and this nomenclature refers to dry weight fructose compositions of 42% and 55% respectively, the rest typically being glucose or glucose and an amount of other carbohydrates.

In a preferred embodiment, the fructose glucose syrups generally contain between 5 wt % and 75 wt % fructose, preferably between 20 wt % and 70 wt %, more preferably between 30 wt % and 60 wt % and more preferably between 35 wt % and 55 wt %. These percentages are on a dry solids basis.

In a preferred embodiment, the fructose glucose syrups generally contain between 5 wt % and 75 wt % glucose, preferably between 20 wt % and 70 wt %, more preferably between 30 wt % and 60 wt % and more preferably between 35 wt % and 55 wt %. These percentages are on a dry solids basis.

Undesirable crystallisation of the sugar in the aerated confectionery can be avoided when the sugar comprises or consists of at least two different sugars, preferably comprising fructose. A suitable blend of sugars is provided by an invert sugar with a sugar conversion percentage at least 10% but below 70%, below 60%, below 50% or below 40%. A conversion rate of 40% to 50% is shown to provide desirable results in the Examples. In some embodiments, the sugar is an invert sugar with a sugar conversion percentage (i.e. degree of hydrolysis) of 20% to 60%, 30% to 50% or 40% to 50%.

The presence of fructose in the sugar mix is highly preferred. Preferably, between 10 wt % and 50 wt % of the sugar (i.e. from 1/10 to ½ of the sugars, preferably at least ⅕) is fructose. More preferably, around 20 wt % to 30 wt %, for example 20 wt % to 25 wt % of the sugars are fructose. This can be achieved either by blending different sugar rich ingredients (such as powder sugars, starch derived syrups or inverted sugar syrup) or by using a partially inverted sugar syrup comprising sucrose, dextrose and fructose.

In a preferred embodiment, the aerated confectionery comprises a sugar mix and the confectionery comprises 5 wt % to 30 wt % sucrose, 5 wt % to 30 wt % glucose syrup and 35 wt % to 75 wt % fructose glucose syrup.

In a more preferred embodiment, the aerated confectionery comprises a sugar mix and the confectionery comprises 10 wt % to 25 wt % sucrose, 10 wt % to 25 wt % glucose syrup and 45 wt % to 65 wt % fructose glucose syrup.

This mixture of sugars in the confectionery may also be defined as a percentage of reducing sugars, because sucrose is a non-reducing sugar while dextrose and fructose are reducing sugars. Accordingly, the sugar in the aerated confectionery preferably comprises at least 10% but less than 70% reducing sugars, with the remainder being non-reducing sugars. In some embodiments, the sugar comprises 10% to 60% reducing sugars, 20% to 60% reducing sugars, or 30% to 50% reducing sugars. The Examples demonstrate the use of a sugar mixture comprising 40 wt % to 50 wt % (specifically 41 wt % to 49 wt %) reducing sugars. The mixture of reducing sugar and non-reducing sugar can be provided as a partially-inverted sugar syrup.

A fully hydrolysed (˜97% inverted) invert syrup, in which essentially all sucrose is broken down to dextrose and fructose, may crystallise in aerated products. A partially hydrolysed syrup, for example hydrolysis above 10% but below 70%, preferably less than 60% hydrolysed (inverted) is more stable according to the present invention and does not crystallise.

In one embodiment, the sugar comprises or consists of partially hydrolysed invert syrup. In another embodiment, the sugar comprises or consists of a mix of sucrose, partially or fully-inverted syrup, and glucose. In a further embodiment, the sugar comprises or consists of a mixture of sucrose, fructose and glucose.

Accordingly, a mixture of sugars is preferably used according to the invention. Preferably the mixture comprises fructose.

Invert sugar may be fully inverted sugar syrup or, preferably, partially inverted sugar syrup. Fully inverted sugar syrup comprises only glucose and fructose. Partially-inverted sugar syrup comprises glucose, fructose and sucrose and is preferred.

Accordingly, a balance or mixture of sugars is preferably provided.

An example of a mixture of sugars used in the Examples comprises a mixture of sucrose, inverted syrup (itself containing sucrose, glucose and fructose) and glucose.

The “221” partially inverted sugar syrup used in some of the Examples is available from British Sugar plc, Peterborough, United Kingdom as “Partial Invert Syrup 221”. It is a pale straw-coloured solution of white sugar in potable water, produced from sugar beet. This syrup comprises 41-49% reducing sugars as determined by Lane & Eynon titration using Fehlings solution and Methylene blue indicator. Invert 221 is a partially inverted sugar syrup so comprises a proportion of non-hydrolysed sucrose along with equal fractions of fructose and dextrose. Compared to fully inverted sugar syrup (only fructose and dextrose) it is less prone to crystallise.

An alternative to IS221 is a mix of sucrose, and fructose-glucose syrup.

In some embodiments, the total amount of sugar in the aerated confectionery is between 60 wt % to 90 wt %, for example 75 wt % to 85 wt %.

In a preferred embodiment, the aerated confectionery comprises 40 wt % to 85 wt % total monosaccharides and disaccharides, preferably 50 wt % to 80 wt %, and more preferably 60 wt % to 80 wt %.

### Aeration

The creation of a mousse involves the introduction of a gas into a liquid mass, either by mechanical introduction of the air (whipping) or via gas injection or both. The term “aerated” is used to encompass air as well as gases other than air, as is standard in the art of aeration of foodstuffs. For example, nitrogen, carbon dioxide, nitrous oxides etc. A high sugar environment presents challenges to the ability to mechanically introduce air because the sugar solution is highly viscous, but temperature can control this by having zones within the process. It is well known that the whippability of a solution decreases with increasing bulk viscosity (FIG. 1A). Once the air is introduced into the liquid surface active molecules need to rapidly adsorb to the interface to prevent the bubbles bursting. To be effective at stabilizing bubbles such emulsifiers need to rapidly adsorb to the interface under convective mixing and they need to form a strong interfacial film to resist Marangoni effects and prevent bubble coalescence once the plateau border has drained (FIG. 2).

The present inventors created ambient stable aqueous mousses for confectionery fillings. They also demonstrated that aqueous mousse fillings of the invention can be stable for at least six months.

The aerated confectionery may be filled into in a chocolate shell or coating. In some embodiments bonbon shells can be used, while in other embodiments tablets may also be used. In some embodiments, the invention provides a confectionery product containing the aerated filling according to the invention. By “chocolate”, the present invention encompasses the use of white, dark and milk chocolate or mixtures thereof, as well as chocolate analogues, such as compound chocolate.

Existing equipment can be used to produce aerated confectionery according to the invention and, optionally, filling chocolate shells with it. Apart from the normal capabilities for production of filled chocolate products (shell making, depositing, backing off) the capability of making the filling is needed. For this the mixing and cooking of water-based ingredients and subsequently aerating them is necessary. Preparation of the filling mass can take place in a batch tank with heating capabilities to 80-90° C. Aeration of the filling can take place in a continuous aerator (e.g. Mondomix) connected to a dedicated water-based line fitted with a CIP system.

### Confectionery Filling Composition

As mentioned above, the water-based aerated confectionery of the present invention is preferably a composition for providing a filling for a confectionery product.

The filing composition of the invention may be a confectionary filling for use in a composite product such as a sandwich, a biscuit, a wafer, or other composite confectionary product. The filling composition may provide a topping, e.g. for use on top of a composite product, or a spread.

However, the most advantageous use of the filling compositions of the present invention is for use as fillings in chocolate or chocolate analogue products.

This is because the present invention allows an increase in stability without significantly affecting texture nor sensory attributes of the filling and the final product. This is particularly important for confectionery products where the eating experience is key for the product.

Furthermore, a long shelf life stability is important for fillings owing to the relatively long shelf life of chocolate and chocolate analogues, i.e. the filling needs to be stable for as long as the chocolate. This is a difference of filling chocolate products as compared to making fillings for sandwich biscuits where the biscuit has a shorter shelf life than chocolate. However, for aqueous-based fillings, the control of the stability and moisture retention is particularly important for confectionery products-moisture leakage may lead to product spoiling.

An embodiment of the present invention provides a foodstuff comprising the filling composition of the present invention, preferably the foodstuff is a confectionery product, preferably a chocolate (or equivalents thereof, such as compound) product.

In a highly preferred embodiment, the present invention provides a filled chocolate or chocolate-analogue shell, filled with the filling of the present invention.

In a preferred embodiment, the filling of the present invention is not-baked, i.e. it is not included in a foodstuff which requires further cooking after the filling has been deposited.

In an embodiment, provided is a filled foodstuff product, preferably a filled chocolate product, preferably a chocolate shell filled with the filling of the invention, that comprises from 5 to 95% by weight of the product of the filling of the invention, preferably from 10 to 90%, preferably from 20 to 70% or from 30 to 50%.

Preferably, the remainder of the product being a shell of chocolate-like material such as compound or chocolate that substantially encloses (for example completely encloses) the product. Hence, in an embodiment, the chocolate-like material may comprise from 5 to 95% by weight of the product, preferably from 10 to 90%, preferably from 30 to 80% or from 50 to 70%.

Another embodiment of the invention provides a chocolate confectionery product, which comprises a filling of the present invention surrounded by an outer layer of a chocolate product, for example, a praline, chocolate shell product, a truffle, a filled-tablet and/or chocolate coated wafer or biscuit any of which may or may not be layered. The chocolate coating can be applied or created by any suitable means, such as enrobing, cold stamping (frozen cone, cold forming, etc.) or moulding.

The above embodiments relating to filled chocolate products are highly preferred.

In an embodiment, compositions of the invention may usefully be chocolate products (as defined herein), more usefully be chocolate or a chocolate compound. Independent of any other legal definitions that may be used compositions of the invention that comprises a cocoa solids content of from 25% to 35% by weight together with a milk ingredient (such as milk powder) may be informally referred to herein as ‘milk chocolate’ (which term also encompasses other analogous chocolate products, with similar amounts of cocoa solids or replacements therefor). Independent of any other legal definitions that may be used compositions of the invention that comprises a cocoa solids content of more than 35% by weight (up to 100% (i.e. pure cocoa solids) may be informally referred to herein as ‘dark chocolate’ (which term also encompasses other analogous chocolate products, with similar amounts of cocoa solids or replacements therefor).

The term ‘chocolate’ as used herein denotes any product (and/or component thereof if it would be a product) that meets a legal definition of chocolate in any jurisdiction and also include product (and/or component thereof) in which all or part of the cocoa butter (CB) is replaced by cocoa butter equivalents (CBE) and/or cocoa butter replacers (CBR).

The term ‘chocolate compound’ as used herein (unless the context clearly indicates otherwise) denote chocolate like analogues characterized by presence of cocoa solids (which include cocoa liquor/mass, cocoa butter and cocoa powder) in any amount, notwithstanding that in some jurisdictions compound may be legally defined by the presence of a minimum amount of cocoa solids.

The term ‘chocolate product’ as used herein denote chocolate, compound and other related materials that comprise cocoa butter (CB), cocoa butter equivalents (CBE), cocoa butter replacers (CBR) and/or cocoa butter substitutes (CBS). Thus, chocolate product includes products that are based on chocolate and/or chocolate analogues, and thus for example may be based on dark, milk or white chocolate.

Unless the context clearly indicates, otherwise it will also be appreciated that in the present invention, any one chocolate product may be used to replace any other chocolate product and neither the term chocolate nor compound should be considered as limiting the scope of the invention to a specific type of chocolate product. Preferred chocolate product comprises chocolate and/or compound, more preferred chocolate product comprises chocolate, most preferred chocolate product comprises chocolate as legally defined in a major jurisdiction (such as Brazil, EU and/or US).

In another preferred embodiment of the invention the foodstuff comprises a multi-layer coated chocolate product comprising a plurality of layers of wafer, chocolate product, biscuit and/or baked foodstuff, with filling sandwiched between them, with at least one layer or coating being a chocolate product (e.g. chocolate). Most preferably the multi-layer product comprises a chocolate product confectionery product (e.g. as described herein) selected from sandwich biscuit(s), cookie(s), wafer(s), muffin(s), extruded snack(s) and/or praline(s). An example of such a product is a multilayer laminate of baked wafer and/or biscuit layers sandwiched with filling(s) and coated with chocolate.

According to another aspect, there is provided a composite product comprising the filling composition according to the invention. The composite product may be, for instance, a sandwich, biscuit, cracker, wafer, or bakery foodstuff product comprising the filling composition of the invention as a filling or as a topping.

Specifically, baked foodstuffs used in the invention may be sweet or savoury. Preferred baked foodstuffs may comprise baked grain foodstuffs, which term includes foodstuffs that comprise cereals and/or pulses. Baked cereal foodstuffs are more preferred, most preferably baked wheat foodstuffs such as wafer(s), cracker(s), cookie(s), muffin(s), extruded snack(s) and/or biscuit(s).

Wafers may be flat or shaped (for example into a cone or basket for ice cream) and biscuits may have many different shapes. More preferred wafers are non-savoury wafers, for example having a sweet or plain flavour.

The invention will now be described in further details in the following non-limiting examples.

### EXAMPLES

### Summary

The inventors studied aerated water-based fillings and understood the challenge of gas bubble stability. They first focused on addressing this stability and concluded that a stable aerated structure can be created using a system that is completely absent of fat. The gas bubbles in this system are stabilised by its viscosity which in turn is built by a combined effect of the sugar system used and aggregated whey protein. In the acidic conditions of the filling (preferably provided by intrinsic acids in fruit juices and coffee or by adding an edible acid) the proteins undergo an irreversible aggregation when heat is applied. The controlled shear applied when this aggregation takes place controls the size of the aggregates. The final system is a viscous suspension of fine protein aggregates. When aerated the protein species stabilise the gas bubbles and the aggregates adsorb on the air/water interface and occupy the channels (plateau borders) creating a robust system with an increased stability over time whilst maintaining a soft indulgent texture.

The inventors then validated these findings in a confectionery environment—production equipment and stability within a chocolate product—by preparing a product using a coffee variant of the aerated filling which is achieved by the addition of Nescafe Classic instant coffee powder.

### Example 1: Stabilization of Ambient Mousses

### A. Stabilization of Ambient Aqueous Mousses by Proteins/Protein Aggregates

The creation of a mousse, especially a mousse with an acidic pH, requires the use of surface active molecules that stabilize the interface of the air bubbles. The key role of the emulsifier is initially to facilitate bubble creation by lowering interface tension and rapidly to stabilize them against coalescence both during the mechanical whipping process and long term during storage. Proteins were deliberately chosen as the key interfacial stabilization agents because of their clean label perception and their ability to stabilize interfaces against coalescence (through interfacial viscoelasticity) (Karbashi et al. (2014)). Both native and modified proteins were investigated in this study. The modifications to the proteins that were studied were either; i) hydrolysis to increase surface activity and solubility (HyFoama VPN (soy/DSN (milk)) and ii) aggregation to slow mousse drainage by clogging the foam nodes.

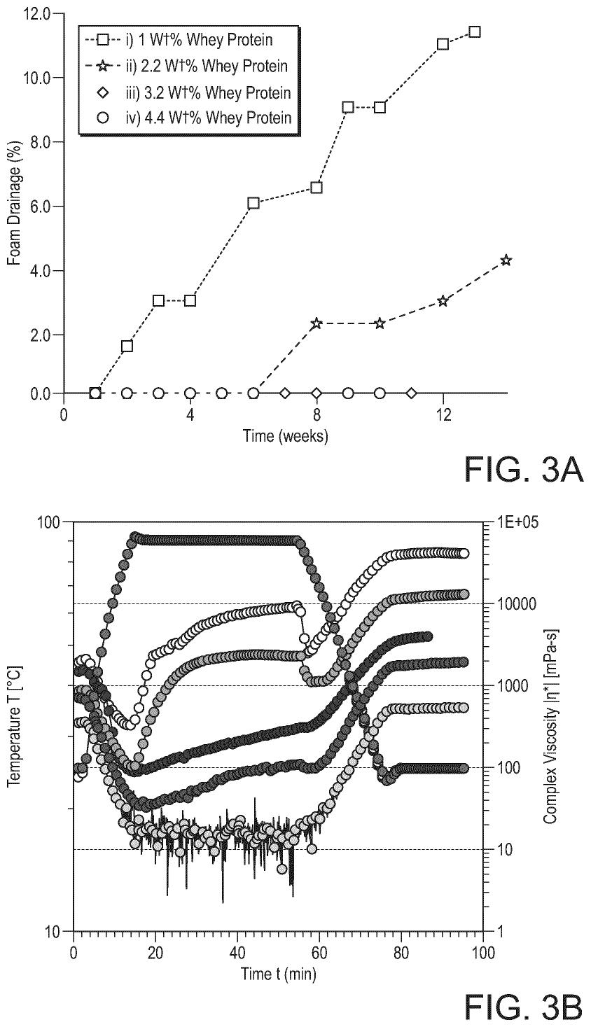

An initial assessment of foaming performance was conducted in order to focus development efforts on those that were most promising in the acidic, high sugar, high overrun conditions of. aqueous mousse fillings. FIG. 2A (overrun) and B (stability) present a summary of the foaming performance of the different protein based emulsifiers tested. All protein based emulsifiers delivered high levels of overrun using a whisk whipping foaming device (Hobart mixer). Gelatin (Type A bloom 280) gave a high overrun of 213±17%, with excellent stability (not shown). Native whey protein isolate (BiPro) gave moderate overrun 90±14%, however aggregation of the whey protein isolate via heating (80° C., 5 minutes) significantly increased foam overrun (160±17%). Foams created from heat aggregated whey protein had good stability (FIG. 3B). Hydrolyded proteins (Hyfoama) dramatically increased foam overrun to between 200 and 250%, however these foams were highly unstable undergoing extensive drainage and disproportionation during one week (FIG. 3B). Therefore, the inventors decided to focus the remaining work on whey protein, in particular on aggregated whey protein given the benefits in stability achieved.

The results presented in FIG. 3 highlight that mousses stabilized by heat aggregated whey protein isolate have good overrun and moderate mousse stability. The concentration of whey protein was systematically increased in order to improve mousse drainage stability. The results of long term mousse drainage studies show increasing mousse stability with increasing protein concentration. Mousses with ≥3.3 wt % protein exhibited no drainage over 11 weeks.

It was hypothesized that higher concentrations of protein would lead to more extensive acid aggregation leading to a great increase in aggregate size and therefore ability to prevent mousse drainage via clogging. There is little study or evidence of whey protein aggregation at acidic pH's. Therefore, experiments were conducted to assess whether protein aggregation was occurring.

FIG. 3B presents the change in low shear rheology of invert syrup/whey protein mixtures as a function of the heating profile as applied during mousse manufacturing. The rheological trace of the invert syrup solution shows a linear decrease in viscosity upon heating, a plateau during the heating step and a linear increase during cooling. These transitions are associated with the changes in mobility of the concentrated sugar solution upon heating and cooling. Addition of protein to these mixtures lead to three systematic changes, i) a modest increase in the initial viscosity, ii) a strong systematic increase in final viscosity relative to initial viscosity which is caused by iii) a steady (and even rapid) growth in solution viscosity during the heating phase which scaled with increasing protein content. The rapid increase in viscosity at 4.4 and 6.6 wt % whey protein is strongly indicative of protein aggregation during this heating phase. Given the acidic pH of this system, the aggregation mechanism is most probably hydrophobic in nature as cysteine cross linking is prevented at such acidic pHs.

Rheological properties of the non-aerated masses were measured by performing oscillatory rheolometry as a function of temperature. These measurements were performed using a Physica MRC 500 rheometer (Anton Paar) equipped with a sanded Couette geometry (CC27-SN23479) and a Peltier system for temperature control. The Couette geometry was composed of a cup (14.46 mm radius) and a bob system (13.33 mm radius,40 mm length). Samples were covered with a low-viscosity silicone oil (Sigma Aldrich Ltd, Singapore) to avoid evaporation during measurements. The sample rested for 5 minutes at 25° C. before starting the experiments. The imposed frequency (1 Hz) and strain (0.5%) during oscillatory shear measurements were chosen within the linear response regime.

### B. Preventing Sugar Crystallization

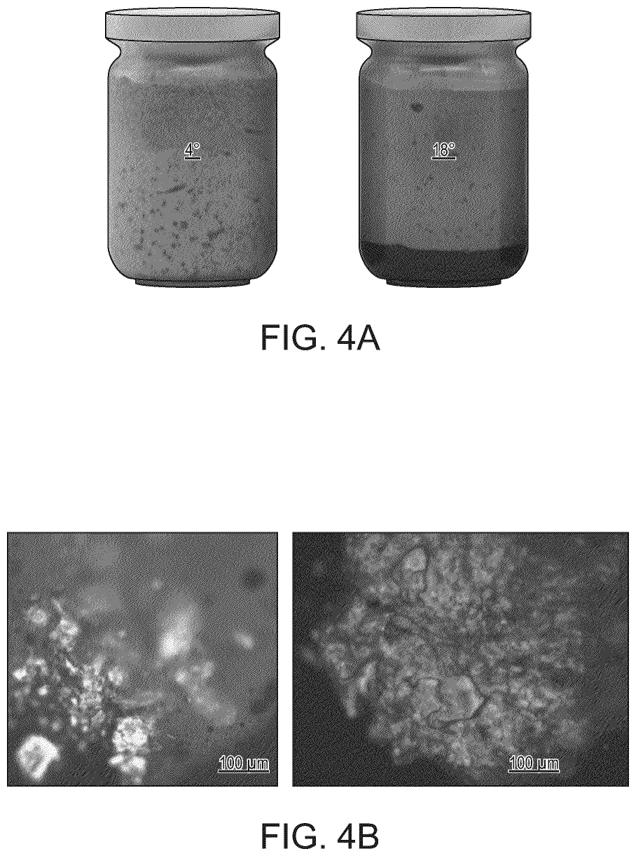

A key defect in ambient aqueous mousse stability that arose during the first shelf life study was crystallization of the sugar syrup used for water activity control. Initial recipes were formulated using invert syrup, in which 70% of the sugars were converted. FIG. 4 presents a photograph and microscopy images of the appearance of sugar crystals during chilled (8° C.) and ambient (18° C.) storage of raspberry mousse fillings. The red spots that appear in the product were analysed by optical microscopy, which revealed that they were comprised of sugar crystals surrounded by liquid raspberry juice concentrate (FIG. 4B).

The problem of sugar humectant crystallization was determined to be associated with the high conversion 70% of the invert sugar in the recipe, which lead to saturation of the fructose/dextrose concentration at ambient/chilled temperatures leading to crystallization of the dextrose over time. The key approach to solve this problem was to prevent creation of a saturated solution of any one single sugar either by blending various sugars (e.g. mix of sucrose, glucose syrup, fructose-glucose syrup or invert syrup) or using an invert sugar with a lower % conversion i.e. a partial invert syrup

The appearance of sugar crystals in raspberry fillings prepared with the two new sugar blends (4 batches and 3 batches) at chilled and ambient temperatures was studied over a period of 6 months. At each time period a separate batch of filling was examined by polarized light microscope and by touch sensation. It was apparent that there was no systematic appearance of sugar crystals in any of the batches of raspberry filling mass over a period of 31 weeks. These results clearly demonstrate that the mixed sugar (mix of sucrose, glucose and invert syrup—Aw—0.54, 0.59, 0.64, 0.66) and the Invert 221 having 41 wt %-49 wt % reducing sugars (Aw—0.54, 0.58, 0.66) are effective solutions to prevent sugar crystallization and act as humectants ensuring product water activity lower than the required 0.67.

### C. Stabilisation by Increasing Bulk Viscosity—Effect of Aw, Sugar Type, Temperature

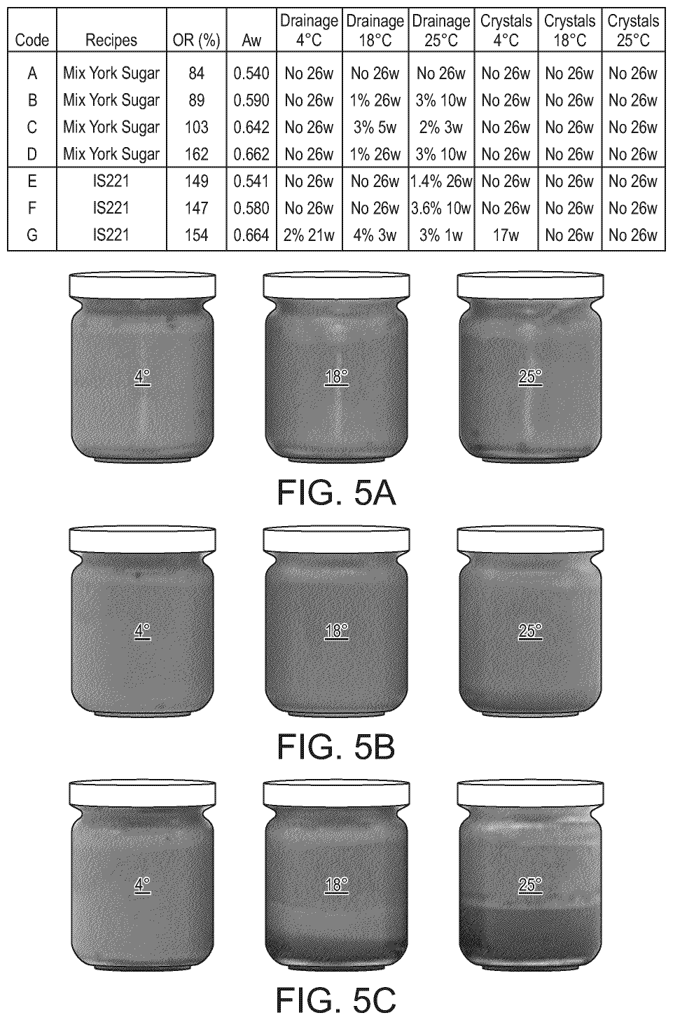

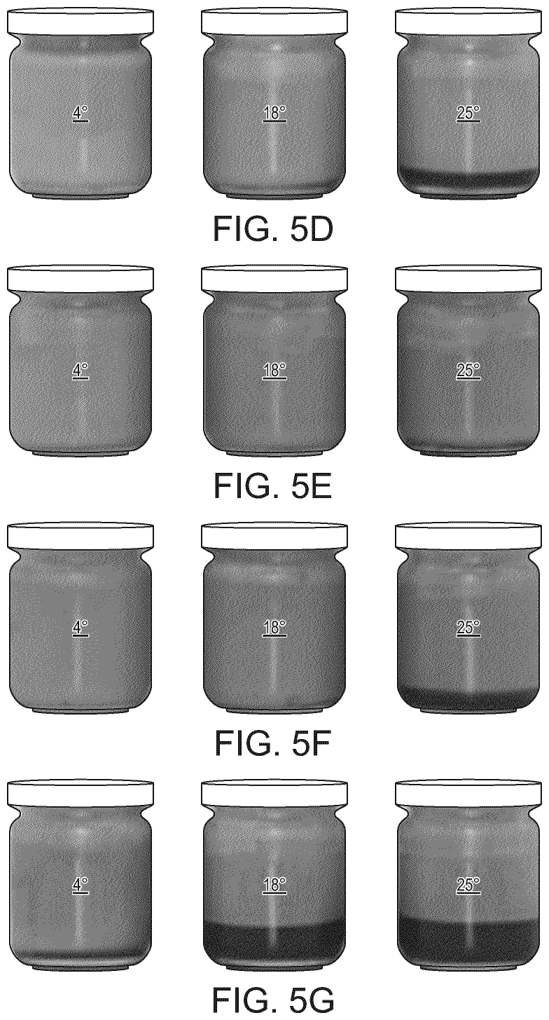

The development of a non-crystallizing sugar mix, such as the exemplified mixture of sucrose, inverted syrup and glucose, or the exemplified partial invert IS 221 having 41 wt %-49 wt % reducing sugars, allowed to further investigate the effect of % overrun (% OR), water activity (Aw) and storage temperature on the drainage rate in the aerated fillings (FIG. 5).

The stability of the aerated fillings against drainage is mainly governed by the Aw at comparable % OR. The lower content of water, the lower is the Aw is, the higher is the viscosity of the continuous phase, and the more stable is the aerated filling over time. Increasing moderately the % OR leaving the Aw more or less constant is another way to increase the stability of the fillings (see mix of sucrose, glucose and invert syrup in samples C and D at 18 and 25° C. where sample D undergoes slower drainage despite a higher Aw due to its higher overrun).

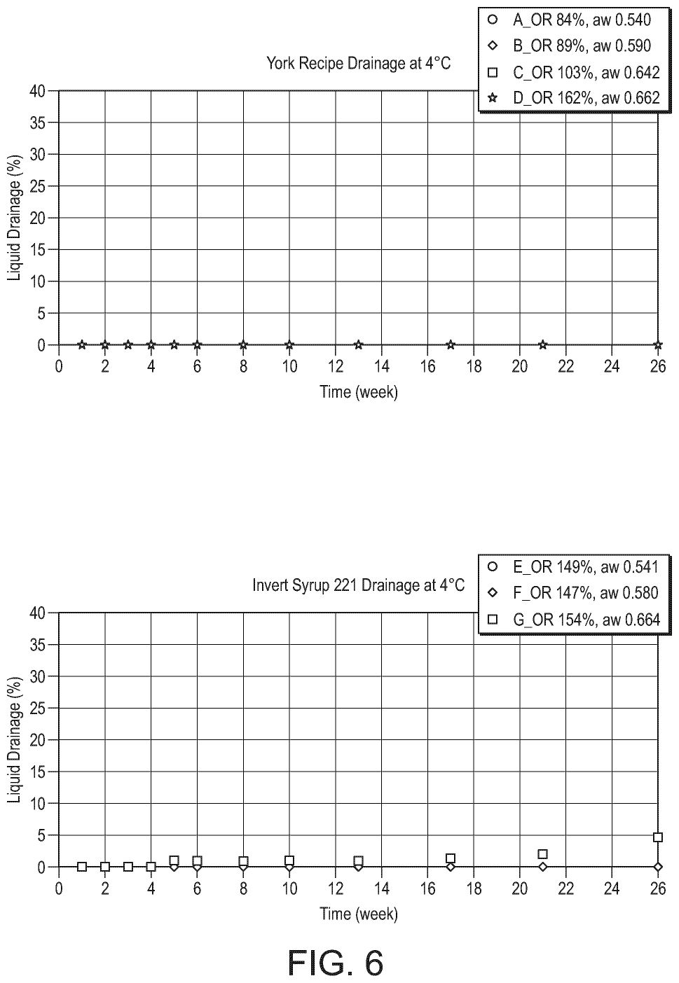

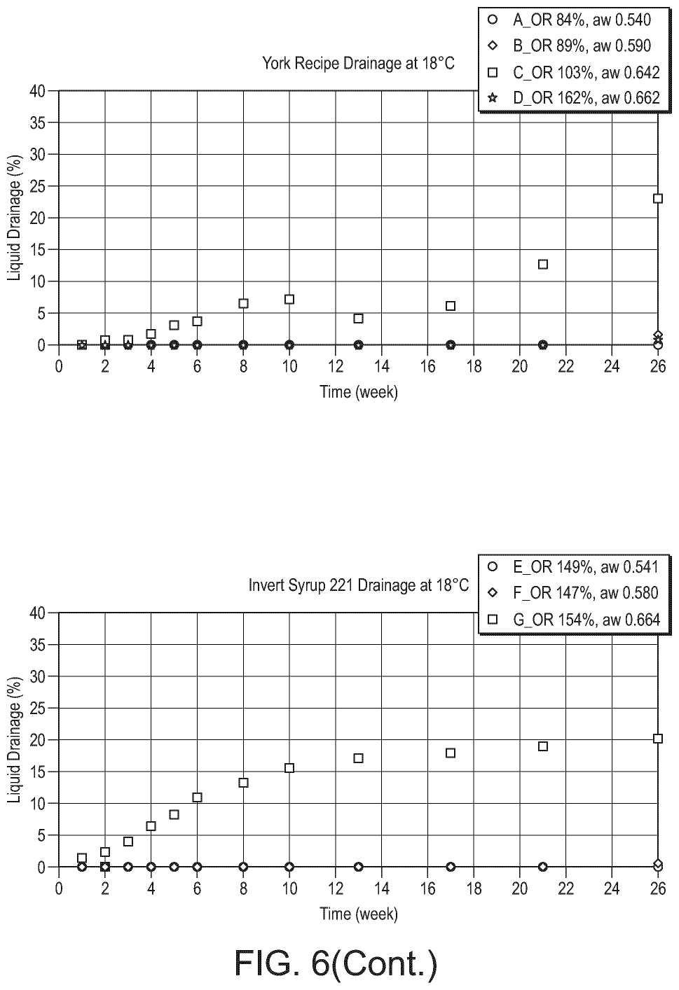

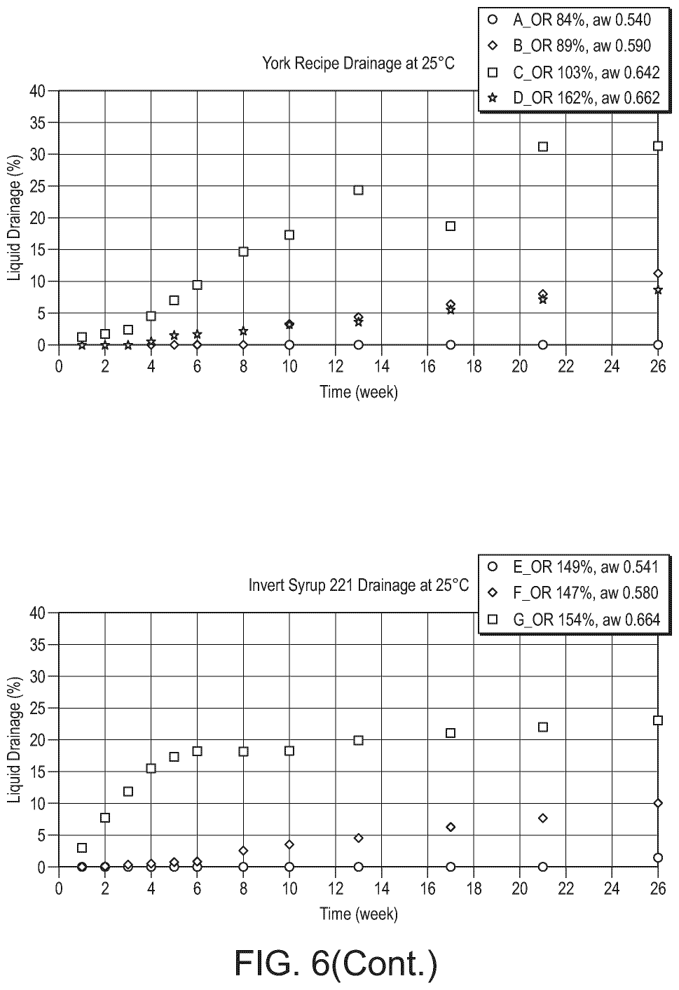

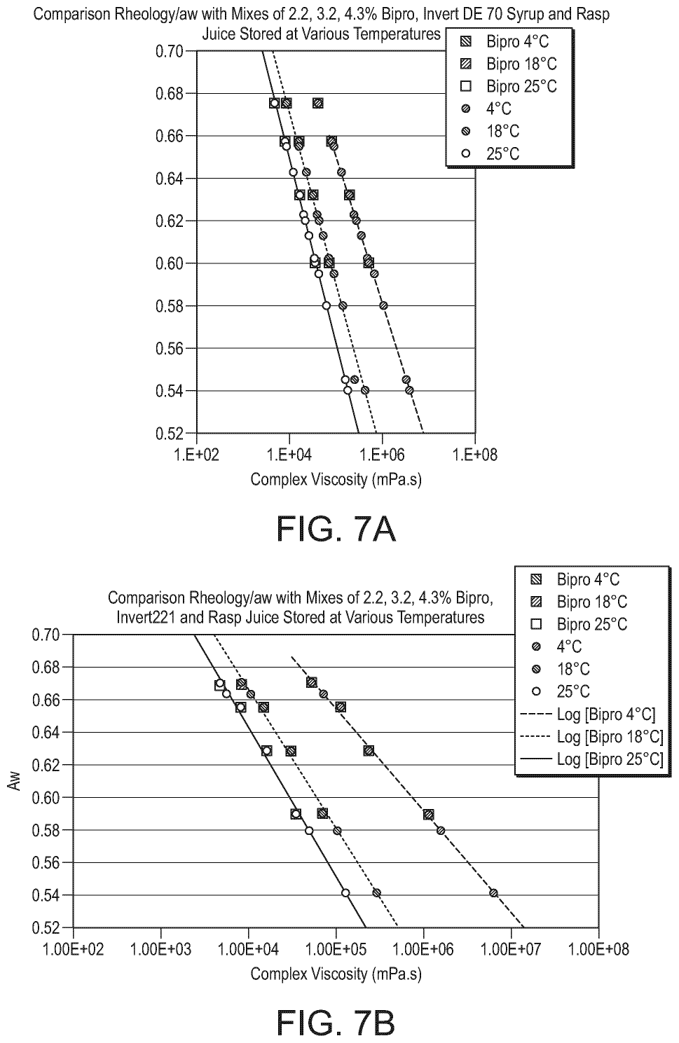

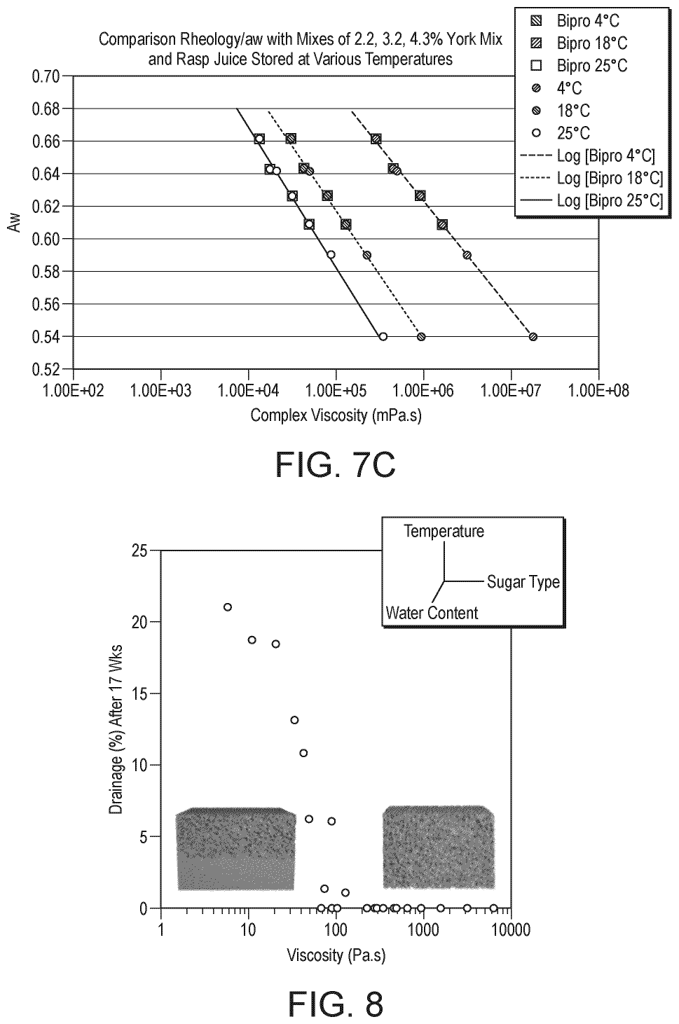

The shelf-life stability test of these mousses (FIGS. 5 and 6), shows clearly that drainage is lowest at refrigerated storage temperatures due to an enhanced viscosity of the continuous sugar phase. It is shown that the aerated fillings are stable for 26 weeks, or even more, at 4° C. When storing the fillings at higher temperatures, the drainage rates increase. When fillings were stored at 18° C. six of the eight fillings had no drainage during 26 weeks storage. The two fillings that underwent drainage had a water activity higher than 0.64 suggesting this to be a critical limit for six months storage at 18° C. Interestingly, sugar mix sample D (mix of sucrose, glucose and invert syrup) which had a water activity higher than 0.64 did not undergo drainage during 26 weeks. This contrasts the results of the sugar mix C (mix of sucrose, glucose and invert syrup) which underwent drainage during storage at 18° C. The different between sugar mix D and sugar mix C is that sugar mix D has a higher overrun. The higher stability of sugar mix D compared to sugar mix C suggests that overrun also plays a key role in stabilizing mousses against drainage. Presumably the higher amount of air increases bubble distortion changing the shape/nature of the plateau border slowing drainage.

To generate stable fillings at 25° C., it was necessary to control the Aw, i.e., decreasing it as much as possible. For instance, samples having an Aw of 0.59 or lower showed good stability against drainage over 26 weeks at 18° C. or 25° C. storage temperature. Note that in all these foams no sugar crystals are visible. These are quite encouraging results demonstrate the ability to create ambient mousses that are stable against drainage and sugar crystallization during 6 months. These concepts design rules were translated into praline recipes and their stability inside the chocolate at 18° C. was assessed over 3 months. No liquid drainage or crystallization was observed in the fillings.

### Overall Conclusions from Example 1

The present inventors created design rules and stabilizer recommendations to create ambient stable aqueous mousses for confectionery fillings and proved that the concept of aqueous mousse fillings can be stable for six months. Systematic studies addressed the following hypotheses: how to stabilize acidic mousses using aggregated proteins; how to prevent mousse drainage by regulating plateau border viscosity; and how to prevent sugar crystallization in the humectant mix by limiting the concentration of a single sugar below its saturation concentration.

Heat induced aggregation of whey protein was shown to improve foam performance, with increasing protein contents showing superior stability. Long term stability studies at ambient and chilled conditions demonstrate that the aqueous raspberry mousses are stable against drainage and sugar crystallization for at least 6 months. The results clearly demonstrated that the stability of ambient stable aqueous mousse fillings is inversely proportional to the bulk viscosity of liquid filling. We have identified three separate levels (water activity, sugar type and temperature) that can be used to control to achieve the critical limit of this central design rule.

### Example 2: Refrigerated or Ambient Egg & Fat Free Aqueous Mousses Stabilized by Less than 5% Whey Protein Isolate, a Hydrocolloid and Sugar for Light Fillings in Confectionery Products

To make and stabilize aqueous based mousses, generally egg based whipping agents, such as egg white proteins or purified proteins from the egg white, e.g. the albumen, are used together with sugar, gelatine or other hydrocolloids. Examples are, for instance, products like meringues, Danish kisses, macaron etc.

In this Example aqueous based mousse recipes are developed, that can be aerated. The aerated model fillings have the following properties:
The whipping agent is a Whey protein isolate (non-egg source); protein 1-5% (wt) in the aqueous phase.
Overruns (degree of aeration) between 200 and 500% can be created. This volume fraction of air in the filling product is responsible for its light sensorial texture properties.
Physical stability of a month (or more) at ambient temperatures can be achieved. At refrigerated temperatures, the stability is expected to be even longer
The mousses have a pleasant fruity taste.
The developed recipes are free of gelatine, free of fat and free of low molecular weight emulsifiers.
An acid pH of 4 or lower contributes to microbial stability

### Examples of Recipes (before Aeration)

| | WPI | Invert | | | | | | |
|---|---|---|---|---|---|---|---|---|
| Recipe | (BiPro) | syrup³ | K-carrageenan | Fruit powder | Lemon juice | pH | Remarks | A_{w} |
| A | 2.3¹ | 69.8 | 0.05² | 2 | — | 4.2 | Stable >1 | |
| | | | | | | | m at | |
| | | | | | | | ambient T | |
| B | 2.3¹ | 69.8 | 0.05² | 2 | 2 | 4.0 | Stable for | 0.68 |
| | | | | | | | 1 m at | |
| | | | | | | | ambient T | |
| C | 2.3 | 68.4 | 0.15² | 2 | 2 | | More | |
| | | | | | | | ‘creamy’ | |
| | | | | | | | texture | |
| | | | | | | | than in 21 d | |

Total water content: ca. 25%
¹using a 30% WPI solution, heat treated
²using a 5% K-carrageenan solution, heat treated adding KCL changes consistency of gel and mousse
³Invert sugar: 72% concentrated: 69% sugar solids are added when adding 85.5% Invert sugar. Glucose syrup can be used instead of the Invert sugar.

### Preparation

1. BiPro, Invert sugar and lemon juice are dissolved in hot water (70° C.), mixed for several minutes
2. Fruit powder and carrageenan solution added to the mix
3. Mix is whipped using a HOBART kitchen mixer.

### Some Additional Remarks

1. K-carrageenan can be replaced with pectin to make the recipe fully ‘Clean Label’.
2. The total sugar amount can be reduced when adding more hydrocolloids and/or WPI.
3. The mousses can also be fabricated using a Mondomix or other rotor stator devices.

### Example 3: Aerated Mousse Recipe and Method Three recipes were made, which were aerated at 2 different levels LOW (0.8 gr/cm³) and HIGH (0.6 gr/cm³)—see table below.

The main difference amongst them is the type of whey protein used. BiPro is a product that is chromatographically isolated and is richer in β-lactoglobulin and in more “native” form. WPI is a standard isolate that can be bought from several suppliers, having similar protein content but in less native state and with higher proportion of a-lactalbumin. Finally, WPC80 is a concentrate, with less protein content. It is currently already used in confectionery in some chocolate recipes.

The amounts have been adjusted to provide the same protein content, aiming here for 3%. The preferred range that works is around 2 to 5%.

Invert 221 is a partially inverted sugar syrup so it has a proportion of non-hydrolysed sucrose in it along with equal fractions of fructose and dextrose. Compared to fully inverted sugar syrup (only fructose and dextrose) it is less prone to crystallise. This can be also replaced with a mix of sugar and fructose-glucose syrup.

This variant was coffee so Nescafe Classic powder at 10% was used.

Other variants based on fruit (using fruit juice and flavour), caramel, chocolate, vanilla etc.

Stability of the chocolate shell is important since the filling, being soft and aerated, it expands in reduced pressure environments (e.g. high altitudes).

| | BiPro recipe | WPI recipe | WPC80 recipe |
|---|---|---|---|
| Invert 221 | 86.7 | 86.48 | 86.08 |
| BiPro | 3.3 | \ | \ |
| WPI | \ | 3.52 | |
| WPC80 | \ | \ | 3.92 |
| Nescafe | 10 | 10 | 10 |
| | 100 | 100 | 100 |

Each of these recipes is explicitly provided as a separate embodiment of the invention.

The coffee is normal Nescafe classic granules.

The method of preparation is set out below.

### Preparation of the Mass

Invert syrup was heated to 60° C. in a double jacketed vessel with mixing

Coffee powder was added and mixed until dissolved (30 min)

Whey powder was then added and mixed until dissolve (30 min)

Temperature was increased to 80° C. and mixing was continued until all the solids were dissolved the mass was smooth (2-3 h).

### Aeration of the Final Filling

The filling was aerated in on pilot plant scale using a rotor/stator system with gas injection point (Mondomix). The mixing head is temperature controlled via a water jacket other parameters that are controllable are the speed of the mixing head, the temperature of the mass entering the mixing head, the pressure in the inlet of the mixing head, pressure inside of the mixing head and back pressure, gas flow and pressure, inlet pump speed. The settings used were adapted from previous trials with similar materials. Two different set of settings were used to ensure a low and high aeration (ca 0.8 and 0.6 gr/cm3 respectively).

The table below provides the details:

| | HIGH | LOW |
|---|---|---|
| Jacket temperature (degree | 40 | 40 |
| Celsius) | | |
| Mixing Head Speed (per | 320 | 320 |
| minute) | | |
| Mixing Head Water | 18 | 18 |
| Temperature (degree Celsius) | | |
| Density (gram per litre) | 0.6 | 0.8 |
| Mondo input pressure (bar) | 6.5 | 6 |
| Mixing Head Pressure (bar) | 6.5 | 4 |
| Back Pressure (bar) | 4 | 2 |
| Pump Speed | 250 | 250 |

The mass was fed to the mixing head at 40° C. to ensure that the viscosity is lower and mixing and bubble incorporation can be facilitated. Then the mass was cooled down as it was aerated to ensure the stabilisation of the bubbles by building up the viscosity. The different pressures (together with the gas flow rate probably) control the aeration level.

The filling comes out aerated and cooled to a lower temperature (around 30° C.) that could then be used directly for filling chocolate shells.

The confections were assessed at manufacture, 1.5 months, 3 months, 6 months and 9.5 months (over at least 6 samples—max 9 samples at T0) The samples were assessed for visible leakage, visible cracks, visible bubbles, filling separation and grittiness. At 6 months it was noted that there were not significant changes, filling separation and bubble quality have remained acceptable. However, there was a low level of filling collapse appearing. None of the samples were perceived as gritty. At 9 months there were minor increases in filling separation and filling collapse and a minor decrease in bubble quality. Again, none of the samples were perceived as gritty. Hence, these examples display the stability of the present invention. There was no visible leakage or cracking. The WPI high sample was lowest in filling collapse and filling separation. The WPI low sample had the best properties in bubble quantity and size.

### Example 4

To confirm the stability and whipping properties of the compositions of the present invention, the following experiments were carried out.

A base recipe containing:

| | Weight | Total solids Contribution |
|---|---|---|
| Ingredient | Percentage | to entire composition |
| Water | 0.4 | 0 |
| Whey Protein (as above) | 3.0 | 3.0 |
| Granular Sucrose | 18.3 | 18.3 |
| Fructose-Glucose syrup | 59.5 | 42.3 |
| (Isosweet 111) | | |
| 63 DE Glucose Syrup | 18.8 | 15.4 |
| Total | 100 | 79.0 |

The fructose-glucose syrup was 71% total solids and 41% fructose (on a dry weight basis).

The overall sugar content (mono- and di-saccharides) was calculated to be 70%. Fructose contributed 25% of the total sugars (dry weight basis).

The non-protein ingredients were mixed together at 40° C. and then the protein was added. The mixture was heated over 55 minutes up to and held at a temperature of 94° C. and then split into a number of batches. Citric acid powder was added in varying amounts to give certain pHs. The composition underwent whipping to give aerated compositions where the density and water activity was measured. The density was measured using a scale and volume calculation, i.e. a bulk density. The taste of the fillings was also informally assessed, with the taste ranging from sweet to sour at the lower pHs. The whipping was assessed visually and by hand to assess how easily the composition could be whipped to introduce air into the mixture. The whipping was assessed on batches both hand-whipped and whipped using a bench-scale food whipper (Hobart, 5 L benchtop mixer, speed setting 3).

| | Citric Acid Powder | | | | Texture | |
|---|---|---|---|---|---|---|
| | (% of final | pH (at | Assessment | | post- | |
| Example 4 | composition) | 25° C.) | of whipping | Density/g/cm3 | whipping | Aw |
| 4.1 | 0 | 6.4 | Difficult | 0.64 | Smooth but | Not |
| (Comparative) | | | to whip | | runny | measured |
| 4.2 | 0.2 | 5.2 | Whippable | 0.75 | Smooth and | 0.59 |
| | | | | | slightly | |
| | | | | | runny | |
| 4.3 | 0.4 | 3.9 | Acceptable | 0.59 | Smooth | 0.59 |
| | | | whipping | | | |
| 4.4 | 0.6 | 3.6 | Acceptable | 0.51 | Firm | 0.59 |
| | | | whipping | | | |
| 4.5 | 0.8 | 3.4 | Good | 0.55 | Firm | 0.60 |
| | | | whipping | | | |
| 4.6 | 1 | 3.0 | Good | 0.46 | Very firm | 0.59 |
| | | | whipping | | | |
| 4.7 | 1.2 | 2.8 | Good | 0.47 | Very firm | 0.60 |
| | | | whipping | | | |
| 4.8 | 1.4 | 2.7 | Good | 0.46 | Very firm | 0.59 |
| | | | whipping | | | |
| 4.9 | 2 | 2.5 | Good | 0.46 | Very firm | 0.59 |
| | | | whipping | | | |

The samples were stored at 20° C. and 65% relative humidity. The compositions were visually assessed after 1, 2 and 3 weeks. The samples had not changed with time.

### Example 5

The base recipe of Example 4.1 was modified to include mango juice concentrate by reducing the amount of fructose-glucose syrup present. The base composition was prepared as above with the required reduction in fructose-glucose syrup and then split into various batches where the additional ingredients were added. Citric acid powder was added to bring the pH to 3.6-3.7 at 25° C. Dehydrated mango powder and oil soluble (OS) colourants were added in the amounts specified below.

| | Mango | | Colour and | | | | |
|---|---|---|---|---|---|---|---|
| | concentrate | | mango powder | | | Texture | |
| | (wt % of final | pH (at | (wt % of final | Assessment | Density | post- | |
| Example 5 | composition) | 25° C.) | composition) | of whipping | g/cm3 | whipping | Aw |
| 5.1 | 4.7 | 3.7 | | Good | 0.48 | Firm | 0.61 |
| | | | | whipping | | | |
| 5.2 | 4.7 | 3.6 | 1.0 mango | Good | 0.48 | Firm | 0.60 |
| | | | powder | whipping | | | |
| 5.3 | 4.6 | 3.6 | 0.1 paprika | Good | 0.57 | Firm but | 0.60 |
| | | | OS colour and | whipping | | slightly runnier | |
| | | | 1.0 mango | | | than Example | |
| | | | powder | | | 5.1/5.2 | |
| 5.4 | 4.6 | 3.6 | 0.2 yellow | Good | 0.61 | Firm but | 0.60 |
| | | | OS colour and | whipping | | runnier than | |
| | | | 1.0 mango | | | Example 5.3 | |
| | | | powder | | | | |

The overall sugar content (mono-and di-saccharides) was calculated to be between 68-70%.

The samples were stored at 20° C. and 65% relative humidity. The compositions were visually assessed after 1, 2 and 3 weeks. The samples had not changed with time.

### Example 6

The base recipe of Example 4.1 was modified to include strawberry concentrate by reducing the amount of fructose-glucose syrup. The same base composition was prepared and then split into various batches where the additional ingredients were added. Additionally, citric acid powder was added to bring the pH to 3.5-3.6 at 25° C. 0.2% oil soluble (OS) red colour and 0.1% oil soluble or water soluble (WS) strawberry flavour were added to prepare the final compositions.

| | Strawberry | | Colour and | | | | |
|---|---|---|---|---|---|---|---|
| | concentrate | | Flavour | | | Texture | |
| | (wt % of final | pH (at | (wt % of final | Assessment | | post- | |
| Example 6 | composition) | 25° C.) | composition) | of whipping | Density/g/cm3 | whipping | Aw |
| 6.1 | 4.7 | 3.6 | | Good | 0.56 | Firm | 0.61 |
| | | | | whipping | | | |
| 6.2 | 4.7 | 3.5 | 0.2 OS colour | Good | 0.58 | Firm | 0.61 |
| | | | | whipping | | | |
| 6.3 | 4.7 | 3.7 | 0.2 OS colour | Whippable | 0.72 | Least firm | 0.58 |
| | | | and 0.1 OS | | | | |
| | | | flavour | | | | |
| 6.4 | 4.7 | 3.6 | 0.2 OS colour | Good | 0.57 | Firm | 0.61 |
| | | | and 0.1 WS | whipping | | | |
| | | | flavour | | | | |

The overall sugar content (mono- and di-saccharides) was calculated to be 68%.

In view of the above results, it is preferred that an excessive amount of oil-soluble additives are not used so as not to potentially impact the whippability of the compositions.

### Example 7

To understand if the above impact on whipping and textures of using OS additives is applicable to other fruit-based fillings, the composition of Example 5.2 was modified to include 4.6% mango concentrate, 1% WS beta-carotene colour and 0.1% WS-mango flavour. The pH was controlled at 3.3 and the product was able to be whipped easily to provide a mousse with a density of 0.51 g/cm3, a firm texture and an AW of 0.59. Accordingly, using higher amounts of WS additives was less impactful on the overall properties than using OS additives.

### Example 8

As shown in Example 4, the texture of the compositions varied in a manner that could potentially impact the flow properties such that industrial level deposition may not be applicable to enable achievable product manufacture. The recipes from Example 4 were aerated using the pilot-plant scale equipment used in Example 3 and deposited onto plates using a Knobel

KCM depositor. Aeration and deposition were assessed visually once completed. The visual assessment of aeration corresponded with Example 4. In respect of depositing, the ease and quality of depositing using the Knobel KCM depositor was found to correspond to the informal texture analysis, with preferential depositing occurring for the samples with a density of greater than 0.50 g/cm3.

It is understood that the Examples and embodiments described herein are for illustrative purposes only and that various modifications or changes in light thereof will be suggested to persons skilled in the art and are to be included within the spirit and purview of this application and scope of the appended claims. All publications, sequence accession numbers, patents, and patent applications cited herein are hereby incorporated by reference in their entirety for all purposes.

The aspects described herein are not limited to specific embodiments, apparatus, or configurations, and as such can, of course, vary. The terminology used herein is for the purpose of describing particular aspects only and, unless specifically defined herein, is not intended to be limiting.

Throughout this specification, unless the context requires otherwise, the word “comprise” and “include” and variations (e.g., “comprises,” “comprising,” “includes,” “including”) will be understood to imply the inclusion of a stated component, feature, element, or step or group of components, features, elements or steps but not the exclusion of any other integer or step or group of integers or steps.

As used in the specification and the appended claims, the singular forms “a,” “an” and “the” include plural referents unless the context clearly dictates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The person of ordinary skill in the art will appreciate that combinations of various embodiments described herein are specifically contemplated (to the extent such combinations are not incompatible). For example, if in one section the specification describes a particular protein for use in the described compositions, and in another section the specification describes particular sugar for use in the described compositions, the specification also specifically contemplates compositions that include the particular protein in combination with the particular sugar. The same holds true for described ranges and any described features of the compositions and methods described herein.

1. A water-based aerated confectionery, wherein the water-based aerated confectionery:
has a pH less than 5.5; and
has a water activity less than 0.67; and
comprises 30 wt % to 90 wt % sugar;
comprises between 1 wt % to 8 wt % protein,
wherein the protein stabilises the water-based aerated confectionery.

2. A water-based aerated confectionery according to claim 1, wherein the confectionery is a mousse or a foam.

3. A water-based aerated confectionery according to claim 1, wherein the confectionery has a pH between 2 and 5.

4. A water-based aerated confectionery according to claim 1, wherein the protein is aggregated.

5. A water-based aerated confectionery according to claim 1, wherein the protein is whey protein.

6. A water-based aerated confectionery according to claim 1, wherein the protein is present in an amount at least 2 wt % of the aerated confectionery.

7. A water-based aerated confectionery according to claim 1, comprising sugar at between 40 wt % and 90 wt %, wherein the sugar comprises:
at least two different sugars; or
an invert sugar with a sugar conversion percentage between 10% and 70%.

8-9. (canceled)

10. A water-based aerated confectionery according to claim 1, which is completely devoid of an ingredient selected from the group consisting of:
fat;
hydrocolloids;
surfactants;
emulsifiers;
dietary fibre;
gelling agents;
thickeners; and
egg-derived products.

11. A water-based aerated confectionery according to claim 1, wherein the water activity of the aerated confectionery is greater than 0.45 and no greater than 0.64.

12. A water-based aerated confectionery according to claim 1, wherein the bulk viscosity of the aerated confectionery is 10-25 Pa·S.

13. A water-based aerated confectionery according to claim 1, having an overrun of 60% to 200%.

14. A water-based aerated confectionery according to claim 1, aerated to a bulk density of less than 0.8 gr/cm³.

15. A water-based aerated confectionery according to claim 1, comprising no more than 3 wt % of a setting agent.

16. A water-based aerated confectionery according to claim 1, comprising:
fruit, fruit juice or fruit concentrate; and
one or more flavourings.

17. A water-based aerated confectionery according to claim 1, wherein the aerated confectionery is stable for at least one month, wherein stability is determined by a lack of visible drainage or sugar crystallisation.

18. A water-based aerated confectionery according to claim 1, wherein the aerated confectionery is stable for six months at 4° C. or 18° C.

19. A water based aerated confectionery according to claim 1, comprising:
5 wt % to 25 wt % fruit concentrate;
2 wt % to 4 wt % aggregated whey protein isolate; and
80 wt % to 90 wt % invert sugar syrup having a conversion of less than 70%.

20. A confectionery product comprising a water based aerated confectionery according to claim 1 surrounded in chocolate.

21. A method of making a water-based aerated confectionery, comprising the steps of:
(i) forming an aqueous liquid mass, wherein the aqueous liquid mass
has a pH less than 5.5; and
has a water activity less than 0.67;
comprises at least 30 wt % sugar; and
comprises between 1 wt % to 8 wt % protein; and
(ii) introducing gas into the aqueous liquid mass.

22. (canceled)

23. A confectionery for aeration, wherein the confectionery:
has a pH less than 5.5; and
has a water activity less than 0.67; and
comprises at least 30 wt % sugar;
comprises between 1 wt % to 8 wt % protein.

24-25. (canceled)
